(19) United States
(12) Patent Application Publication
(10) Pub. No.: US 2015/0081969 A1
(43) Pub. Date: Mar. 19, 2015

(54) STORAGE APPARATUS AND CONTROL METHOD THEREOF, AND RECORDING MEDIUM

(71) Applicant: NEC Corporation, Tokyo (JP)

(72) Inventor: Eiji TANAKA, Tokyo (JP)

(21) Appl. No.: 14/488,319

(22) Filed: Sep. 17, 2014

(30) Foreign Application Priority Data
Sep. 19, 2013 (JP) 2013-194365

(51) Int. Cl. G06F 3/06

(52) U.S. Cl. CPC G06F 3/0644; G06F 3/0604; G06F 3/0689; G06F 3/0665; G06F 2003/0695; G06F 2003/0697
USPC 711/114

(57) ABSTRACT

To distribute a load on storage devices by distributing accesses to the storage devices in a storage apparatus. The storage apparatus includes one or more storage groups that are configured with one or more storage devices and provide specific storage spaces included in the one or more storage devices as first physical storage spaces by associating the specific storage spaces, and a storage controller that configures a second storage space by associating a plurality of first logical storage spaces associated with the first physical storage spaces and provides an external apparatus with a logical disk, to which the configured second logical storage space is allocated, as a storage space.

This application is based upon and claims the benefit of priority from Japanese Patent Application No. 2013-194365, filed on Sep. 19, 2013, the disclosure of which is incorporated herein in its entirety by reference.

### TECHNICAL FIELD

The present invention relates to a storage apparatus and a control method thereof and a recording medium, which distributes a processing load on a storage device storing data, and improves access performance to the storage device, by distributing an access to the storage device.

### BACKGROUND ART

Recent years, storage apparatuses which make it possible to secure reliability of the apparatuses, while fulfilling requirement for enlargement of a data capacity and improvement in speed of a data access, have been applied. Such storage apparatuses are equipped with, for example, a plurality of hard disk drives (HDD) and/or semiconductor storage devices. Such storage apparatuses, provide a host machine with an integrated logical disk, by functionally integrating these drives and/or devices by a technology such as RAID (Redundant Arrays of Inexpensive Disks). Such a logical disk provides a logical storage space (storage region) which is accessible from the host machine side.

Such storage apparatuses manage physical extents and logical extents by defining associations therebetween. The physical extents are configured by dividing a physical storage space included in a redundancy group which is configured by integrating a plurality of physical storage devices by using the above-described RAID technology or the like. The logical extents compose the above-described logical disk. An access by the host machine to the logical disk is eventually transferred to a physical storage device among the plurality of physical storage devices by using information specifying such associations.

The physical extents generally belong to a specific redundancy group in the above-described storage apparatus. An access to a specific logical extent is converted to an access to a physical extent associated with the logical extent, and an access to a storage device composing a specific redundancy group is eventually generated. Therefore, when concentrated accesses are occurred on a particular logical extent, concentrated accesses to a particular physical storage device may also take place.

Reducing the sizes of logical extents and physical extents so that access requests from the host machine side are distributed over a plurality of the logical extents and the physical extents is one method to alleviate such access concentration as described above. However, simply reducing the sizes of these extents increases the number of those extents.

When the number of those extents increases, management information on each extent (e.g. association information between extents, size information about each extents, assigned address, and so on) increase, that causes a storage space to store the management information to increase.

As a result, decreasing physical storage capacity of the storage apparatus by storing the increased management information, may cause to decrease usage efficiency of a storage capacity supplied by the storage apparatus.

Technologies to alleviate the above-described access concentration on a particular storage space are disclosed by, for example, the following documents.

In a technology described in patent literature 1 (Japanese Patent Application Laid-Open No. 2009-217700), statistical information on data accesses to a particular physical extent is collected. The technology disclosed in patent literature 1 changes a physical extent corresponding to a logical extent to another physical extent, based on the collected statistical information, when a copy volume of a logical disk which includes a logical extent associated with the physical extent is created.

According to the technology disclosed in patent literature 1, there is a possibility that concentration of accesses to a physical storage device is lessened at the timing of copy volume creation of a logical disk.

patent literature 2 (Japanese Patent Application Laid-Open No. 2007-149068) discloses a technology to rebalance an access load by rearranging existing striped data when a new storage device is added to a storage apparatus. According to the technology patent literature 2 discloses, there is a possibility that concentration of accesses to an existing storage device is lessened by rebalancing of data when a new storage device is added to a storage apparatus.

A technology to lessen the above-described increase of management information of extents is disclosed in, for example, the following Patent literature.

patent literature 3 (Japanese Patent Application Laid-Open No. 2010-211681) discloses a technology to adjust the size of management information of relations between physical extents and logical extents. In the technology patent literature 3 discloses, when the size of management information on physical extents increases due to expansion of storage devices or a reduction in physical extent size, logical extents associated with the physical extents are grouped. With this configuration, the technology disclosed in patent literature 3 reduces the size of management information. The technology disclosed in patent literature 3 ungroups the above-described grouping, when the above-described size of management information on physical extents decreases due to removal of a storage device or an increase in physical extent size.

### SUMMARY

### Summary of Invention

### Technical Problem

As described above, for a storage apparatus that manages physical extents, which compose a physical storage space on storage devices, and logical extents, which compose a logical disk, by defining associations therebetween, there is an issue such that a load on the storage devices needs to be distributed. That is, such a storage apparatus is required to distribute a load on the storage devices by distributing an access to each extent.

The above-described patent literatures 1 and 2 only disclose technologies to lessen access concentration on a storage device at a particular timing. The above-described patent literature 3 only discloses a technology to adjust the size of management information on logical extents and physical extents, therefore, a measure to distribute accesses to particular storage devices, while a storage apparatus is in operation, is insufficient.

Accordingly, one of principal objects of the present invention is to provide a storage apparatus or the like which makes it possible to distribute accesses to storage devices while the storage apparatus is in operation.

### Solution to Problem

In order to achieve the above-described object, a storage apparatus according to one aspect of the present invention includes the following configuration. The storage apparatus according to one aspect of the present invention includes one or more storage groups that are configured with one or more storage devices, associate specific storage spaces included in the one or more storage devices and provide the associated specific storage spaces as first physical storage spaces, and a storage controller that configures a second logical storage space by associating a plurality of first logical storage spaces associated with the first physical storage spaces, and provides an external apparatus with a logical disk, to which the configured second logical storage space is allocated, as a storage space.

A control method of a storage apparatus according to one aspect of the present invention includes the following configuration. The control method of the storage apparatus according to one aspect of the present invention includes associating specific storage spaces included in one or more storage devices composing a storage group, configuring the associated specific storage spaces as first physical storage spaces, configuring a second logical storage space by associating a plurality of first logical storage spaces associated with the first physical storage spaces, and, providing an external apparatus with a logical disk, to which the configured second logical storage space is allocated, as a storage space.

A non-transitory computer readable recording medium according to one aspect of the present invention includes the following configuration. The recording medium according to one aspect of the present invention is a non-transitory computer readable recording medium storing a control program for a storage apparatus, the control program causing a computer to execute associating specific storage spaces included in one or more storage devices composing a storage group, configuring the associated specific storage spaces as first physical storage spaces, configuring a second logical storage space by associating a plurality of first logical storage spaces associated with the first physical storage spaces, and, providing an external apparatus with a logical disk, to which the configured second logical storage space is allocated, as a storage space.

### Advantageous Effect of Invention

According to the present invention described above, because an access to data stored in a storage apparatus of the present invention is distributed over storage devices arranged in different storage groups, it is possible to reduce a load on the storage devices and to improve access performance.

### BRIEF DESCRIPTION OF THE DRAWINGS

Exemplary features and advantages of the present invention will become apparent from the following detailed description when taken with the accompanying drawings in which:

FIG. 1 is an exemplary diagram illustrating a functional configuration of a storage apparatus according to a first exemplary embodiment of the present invention;

FIG. 2 is an exemplary diagram illustrating an example of a redundant configuration of each storage device composing a storage device group according to the first exemplary embodiment of the present invention;

FIG. 3 is an exemplary diagram illustrating an example of a relation between a logical disk and physical extents according to the first exemplary embodiment of the present invention;

FIG. 4 is an exemplary diagram illustrating an example of a relation between a logical extent and a physical extent in a technology related to the present invention;

FIG. 5 is an exemplary diagram illustrating an example of a relation between a logical extent and a physical extent according to the first exemplary embodiment of the present invention;

FIG. 6 is an exemplary diagram illustrating an example of a redundant configuration of each storage device composing a storage device group according to a second exemplary embodiment of the present invention;

FIG. 7 is an exemplary diagram illustrating an example of a configuration management memory according to the second exemplary embodiment of the present invention;

FIG. 8 is an exemplary diagram illustrating an example of a configuration employable as multi-extent according to the second exemplary embodiment of the present invention;

FIG. 9 is a flowchart illustrating an example of a configuration process of a logical disk including multi-extent according to the second exemplary embodiment of the present invention;

FIG. 10 is an exemplary diagram illustrating an example of a configuration process of a logical disk according to the second exemplary embodiment of the present invention;

FIG. 11 is an exemplary diagram illustrating an example of the configuration process of the logical disk according to the second exemplary embodiment of the present invention;

FIG. 12 is an exemplary diagram illustrating an example of the configuration process of the logical disk according to the second exemplary embodiment of the present invention;

FIG. 13 is an exemplary diagram illustrating an example of the configuration process of the logical disk according to the second exemplary embodiment of the present invention;

FIG. 14 is a flowchart illustrating an example of processing to determine a physical address associated with a logical address according to the second exemplary embodiment of the present invention;

FIG. 15 is an exemplary diagram illustrating an example of associations between logical addresses and physical addresses according to the second exemplary embodiment of the present invention;

FIG. 16 is an exemplary diagram illustrating an example of associations between logical addresses and physical addresses according to the second exemplary embodiment of the present invention;

FIG. 17 is an exemplary diagram illustrating an example of associations between logical addresses and physical addresses according to the second exemplary embodiment of the present invention:

FIG. 18 is an exemplary diagram illustrating an example of associations between logical addresses and physical addresses according to the second exemplary embodiment of the present invention;

FIG. 19 is an exemplary diagram illustrating an example of configurations employable as multi-extent according to exemplary embodiments of the present invention:

FIG. 20 is an exemplary diagram illustrating an example of configurations employable as multi-extent according to the exemplary embodiments of the present invention; and

FIG. 21 is an exemplary diagram illustrating an example of a hardware configuration of a storage apparatus according to each exemplary embodiment of the present invention.

### EXEMPLARY EMBODIMENT

Next, exemplary embodiments of the present invention will be described in detail below with reference to the accompanying drawings.

### First Exemplary Embodiment

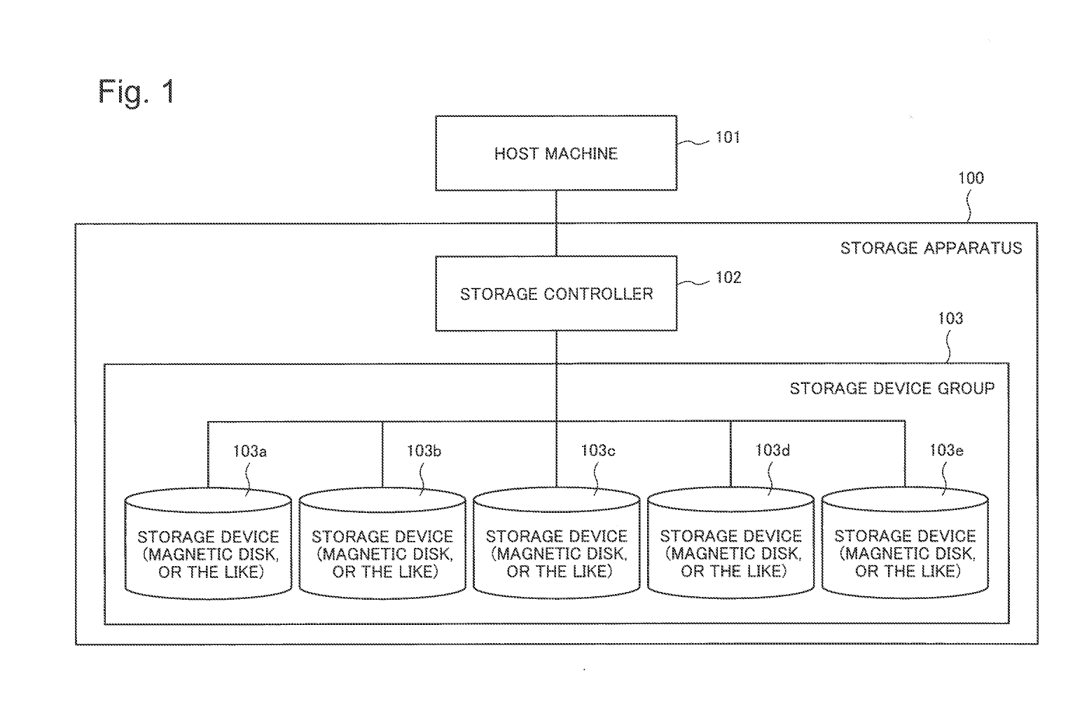

A storage apparatus according to a first exemplary embodiment of the present invention will be described below with reference to FIG. 1. FIG. 1 is an exemplary diagram illustrating a functional configuration of the storage apparatus according to the first exemplary embodiment.

As illustrated in FIG. 1, the storage apparatus 100 of the first exemplary embodiment includes a storage controller 102 configured to control the whole of the storage apparatus and a storage device group 103 including one or more storage devices configured to store data. The storage apparatus 100 of the first exemplary embodiment provides a host machine 101 with a storage space by using these components. Each component will be described below.

The storage device group 103 includes one or more storage devices (storage devices 103a to 103e exemplified in FIG. 1). The one or more storage devices store data as a target of an access request, e.g. reading or writing, from the host machine 101.

For the storage device group 103, a redundant configuration may be configured by integrating the above-described storage devices by using a technology such as RAID. With such a configuration, the storage device group 103 makes it possible to achieve improvement of speed of data access and enlargement of capacity, and to establish reliability as an apparatus.

Each of the storage devices (e.g. the storage devices 103a to 103e exemplified in FIG. 1) composing the storage device group 103 may be any type of storage medium which is able to store data. For example, each of the above-described storage devices may be a hard disk drive (HDD) or a non-volatile storage device such as an SSD (solid state drive) employing non-volatile semiconductor memories.

Although the storage devices 103a to 103e are exemplified as storage devices composing the storage device group 103 in FIG. 1, the first exemplary embodiment is not limited to the example illustrated in FIG. 1. The number of storage devices composing the storage device group 103 may be determined properly and appropriately in accordance with requirements such as storage capacity and access performance required for the storage apparatus 100.

The storage controller 102 is communicably connected to the host machine 101, and functions as a connection interface with the host machine 101.

The storage controller 102 provides the host machine 101 with a logical disk, which is a logical storage space. The storage controller 102, for example, carries out data access processing such as reading and writing data from/to the storage device group 103 in response to a data access request to the logical disk.

The host machine 101 may be connected to the storage controller 102 by using well-known storage connection technologies such as FB (Fiber Channel) and iSCSI (Internet Small Computer System Interface) so as to configure a SAN (Storage Area Network), for example.

For connection between the host machine 101 and the storage controller 102, an arbitrary proper technology may be employed appropriately in accordance with an environment in which the host machine 101 and the storage apparatus 100 are installed, or the like, without limited to the above-described example.

The storage controller 102 is communicably connected to the storage device group 103, and is able to access data stored in each storage device composing the storage device group 103. An arbitrary proper technology may appropriately be employed for connection between the storage controller 102 and the storage device group 103 in accordance with the configuration of each component.

For example, when the storage controller 102 implements the RAID control, the storage controller 102 may be connected to each storage device via a connection interface to which the storage device conforms, such as SCSI (Small Computer System Interface) and ATA (Advanced Technology Attachment).

When the RAID control is implemented by the storage device group 103, the storage controller 102 may be connected to a RAID control unit (not illustrated) implemented in the storage device group 103 by using, for example, various types of communication bus or a memory-mapped IO (Input Output) which uses a specific shared memory.

Specific functions of the storage controller of the first exemplary embodiment will be described later.

The host machine 101 is any apparatus that uses the storage apparatus 100 as a storage space and requests data accesses to the storage apparatus 100. The host machine 101 of the first exemplary embodiment may be any apparatus that needs to access some data, for example, such as any computer which composes various servers such as a file server, database server, and electronic mail server, or any printer.

Next, an operation of the storage apparatus of the first exemplary embodiment will be described below.

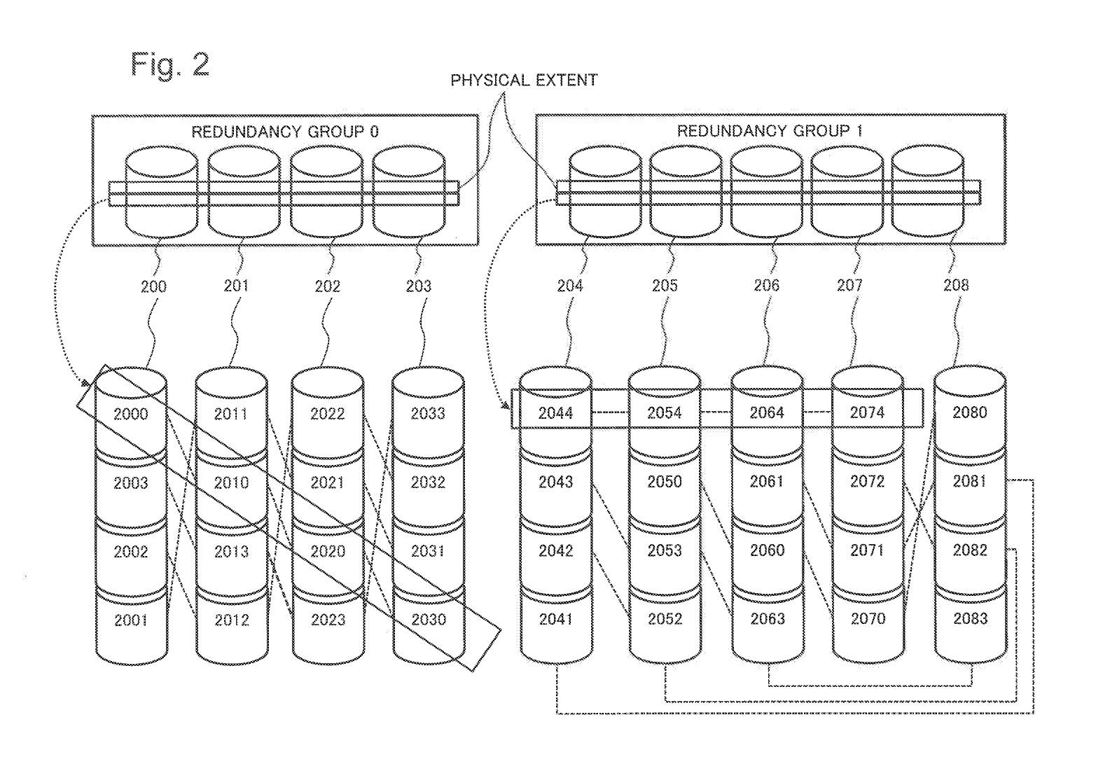

First, the storage device group 103 will be described. FIG. 2 is an exemplary diagram illustrating an example of a redundant configuration of each storage device composing the storage device group 103 according to the first exemplary embodiment. In the first exemplary embodiment, storage devices (e.g. the storage devices 103a to 103e exemplified in FIG. 1) composing the storage device group 103, for example, may be integrated so as to configure a redundant configuration by using the above-described RAID technology or the like. Each of the above-described storage devices of the first exemplary embodiment, for example, may be a magnetic disk device such as an HDD.

In the configuration exemplified in FIG. 2, the storage device group 103 configures a redundancy group 0 with four storage devices 200 to 203 and a redundancy group 1 with five storage devices 204 to 208. Each redundancy group may employ a well-known redundant configuration, for example, specified in the above-described RAID technology. In the configuration exemplified in FIG. 2, a redundant configuration by RAID level 6 (hereinafter, may be referred to as RAID 6) is employed.

In general, a redundant configuration by RAID 6 is implemented with at least four storage devices, including two storage devices for storing data and the other two storage devices for storing parity, which are redundant data for the purpose of fault recovery. However, when a storage space of each storage device is divided into four areas, a redundant configuration of RAID 6 can be constructed even if the number of storage devices is not four. For example, a method of HDD partitioning can be used for division of the storage space as described above.

Referring to the configuration exemplified in FIG. 2, storage spaces on the storage devices 200 to 208 are divided into four partitions, respectively. On the storage devices 204 to 208 composing the redundancy group 1, a redundant configuration of RAID 6 is implemented by combining (associating), for example, partitions 2044, 2054, 2064, and 2074, partitions 2050, 2060, 2070, and 2080, partitions 2041, 2061, 2071, and 2081, partitions 2042, 2052, 2072, and 2082, and partitions 2043, 2053, 2063, and 2083.

In the storage apparatus 100 of the first exemplary embodiment, a physical extent 1 may be configured with, for example, a certain amount of spaces selected from partitions on these multiple storage devices. In the storage apparatus 100, a physical extent 2 is further configured with a certain amount of spaces selected from partitions succeeding the partitions composing the physical extent 1, and, by repeating this process, “n” number of physical extents may be configured. In the other word the storage apparatus 100 provides a physical extent by selecting a certain amount of spaces from associated partitions on these multiple storage devices.

In the first exemplary embodiment the capacity of every physical extent may be identical, for example.

The storage device group 103 of the first exemplary embodiment provides the storage controller 102 with the configured physical extents described above. Moreover, the storage device group 103 of the first exemplary embodiment may provide the storage controller 102 with information about the size, the number, or the like of physical extents which can be provided by the storage device group 103. The storage device group 103 may also provide the storage controller 102 with information about recording conditions (whether or not data are recorded) of physical extents or the like, for example.

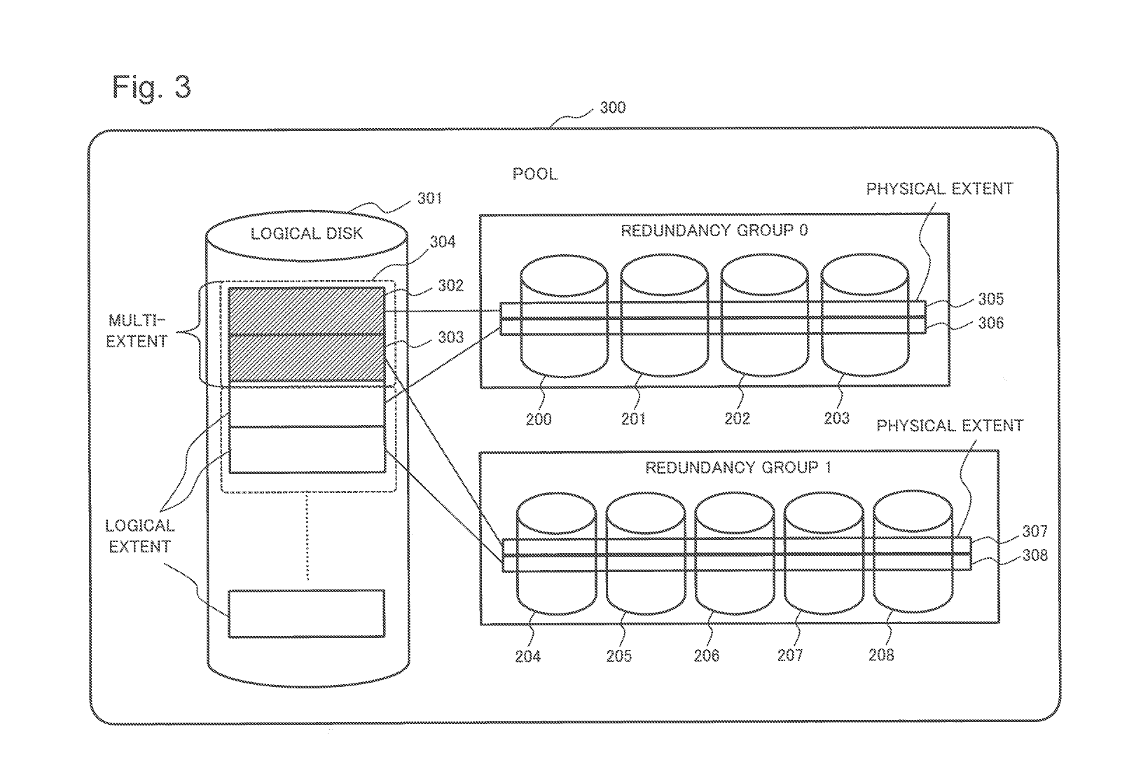

Next, referring to FIG. 3, a method for the storage controller 102 to associate a redundancy group provided by the storage device group 103 with a logical disk to be provided to the host machine 101 as a storage space will be described.

FIG. 3 is an exemplary diagram illustrating an example of a relation between a logical disk 301 and physical extents each redundancy group provides according to the first exemplary embodiment. In the first exemplary embodiment, a concept of a “capacity pool” (hereinafter, may be referred to as “pool”) is introduced, and physical extents configured in one or more redundancy groups may be provided to the host machine 101 as a logical disk by integrating the physical extents.

In the configuration exemplified in FIG. 3, a pool 300 includes the redundancy group 0 and redundancy group 1 exemplified in FIG. 2. Physical extents belonging to each redundancy group also belong to the pool 300. In the first exemplary embodiment, the logical disk 301, which is provided to the host machine 101 as a storage space, is configured in the pool 300.

The storage controller 102 of the first exemplary embodiment configures the logical disk 301 created in the pool 300 as a set of logical extents, each of which is a unit of logical storage. In this case, the storage controller 102, for example, may manage the logical disk 301 by dividing the logical disk 301 using a logical extent as a division unit. In the first exemplary embodiment, because the logical disk 301 is configured by allocating one or more logical extents, the larger the capacity (size) of the logical disk 301 becomes, the more number of logical extents compose the logical disk 301.

The storage controller 102 of the first exemplary embodiment manages the above-described logical extents, and physical extents that are provided by each redundancy group, by defining associations therebetween. The storage controller 102 associates every logical extent composing the logical disk 301 with a physical extent, that is provided by the redundancy group. As a result, the logical disk 301 is associated with specific storage spaces in physical storage devices.

A basic operation of the storage controller 102 in the first exemplary embodiment configured as described above will be described below, with regard to a case in which an access request from the host machine 101 to a specific area in the logical disk 301 is received by the storage controller 102. First, the storage controller 102 extracts a target logical address, to be accessed, included in the access request. Next, the storage controller 102 selects a logical extent including the logical address, and selects a physical extent associated with the selected logical extent. Next, the storage controller 102 computes an offset address of the selected physical extent from a beginning position. The storage controller 102 further computes a physical address of the selected physical extent based on the computed offset address and identifies (an address of) a storage space associated with the physical address on the storage device.

Next, a configuration by which an access load on the storage devices is distributed in the first exemplary embodiment will be described.

In the storage controller 102 of the first exemplary embodiment, a logical storage space hereafter referred to as “multi-extent”, which is configured by a plurality of logical extents, is introduced (applied). The storage controller 102 distributes a data access to logical addresses provided by the multi-extent over a plurality of physical storage devices. Referring to FIG. 3, a configuration of a multi-extent of the first exemplary embodiment will be described below.

For example, the storage controller 102 selects a plurality of unused physical extents from one or more different redundancy groups, when, configuring the logical disk 301. In the first exemplary embodiment, an unused physical extent is a physical extent that is not associated with any logical extent composing a logical disk.

When the above-described physical extents are selected, the storage controller 102 associates logical extents composing the logical disk 301 with the selected physical extents in order.

Next, the storage controller 102 configures multi-extent by assembling the logical extents associated with the physical extents which is belonging to different redundancy groups.

In the configuration exemplified in FIG. 3, the storage controller 102 associates a logical extent 302 with a physical extent 305 belonging to the redundancy group 0 and a logical extent 303 with a physical extent 307 belonging to the redundancy group 1. The storage controller 102 configures a multi-extent 304 by assembling the logical extents 302 and 303 which are associated with physical extents each of which belongs to a different redundancy group.

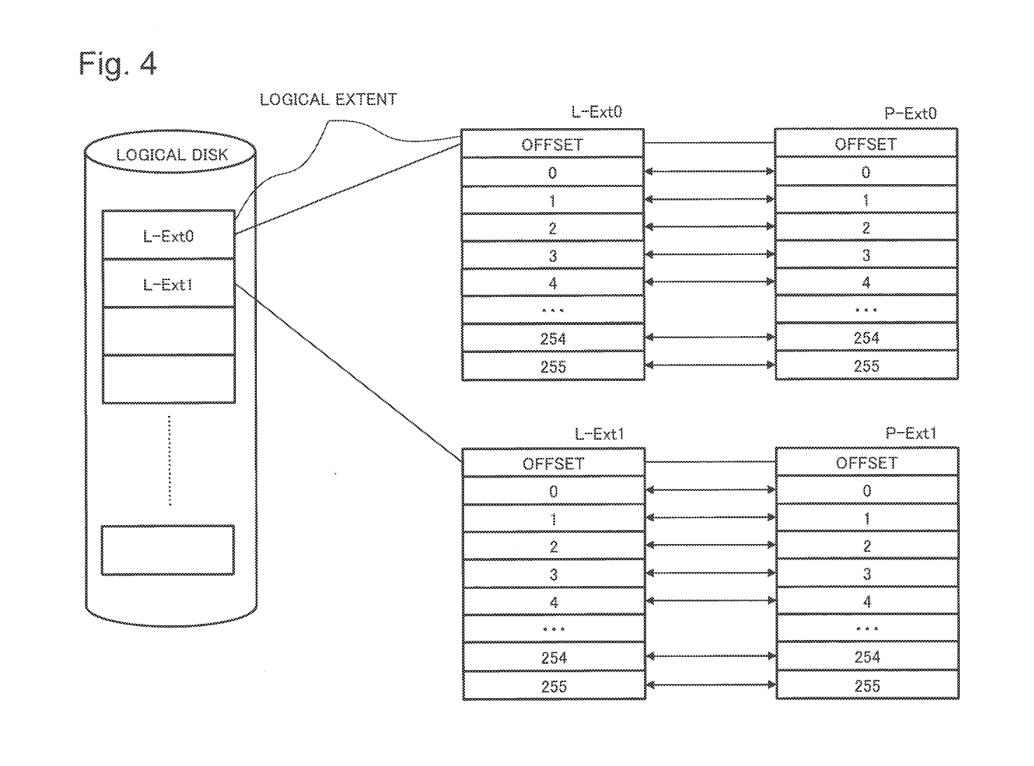

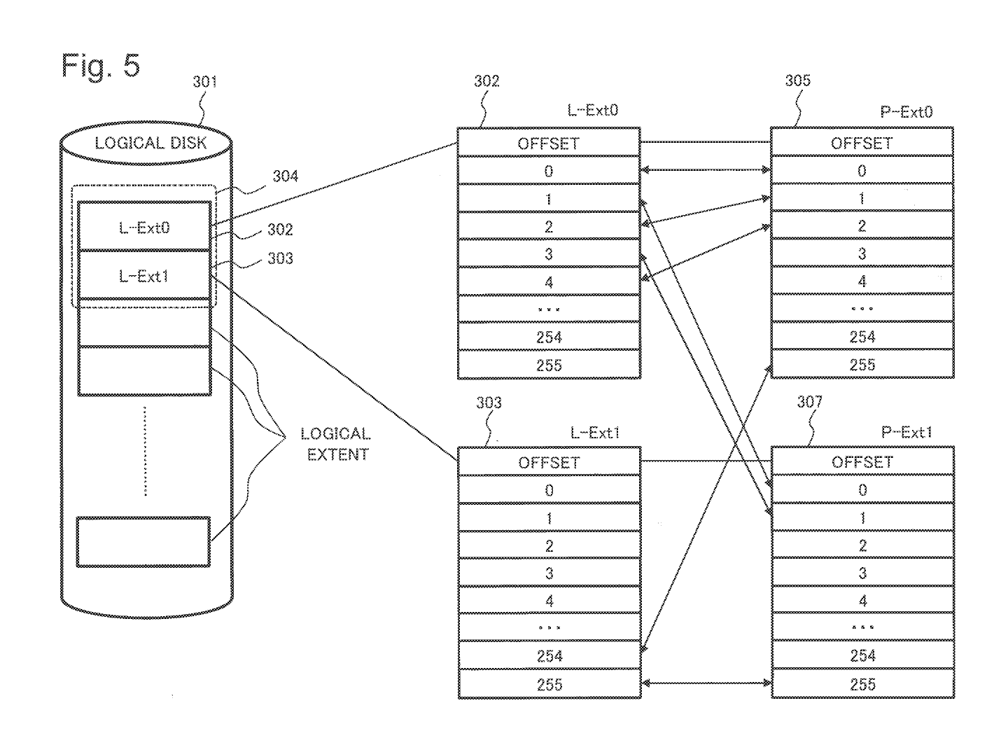

Next, referring to FIGS. 4 and 5, handling of the above-described multi-extent of the first exemplary embodiment will be described. FIG. 4 is an exemplary diagram illustrating an example of relations between the above-described logical extents and physical extents when a multi-extent is not applied. FIG. 5 is an exemplary diagram illustrating an example of relations between the above-described logical extents (multi-extent) and physical extents when a multi-extent is applied.

As illustrated in FIG. 4, in a generally-used configuration, for which a multi-extent is not applied, a logical extent is, in general, associated with a physical extent on a one-to-one basis. The storage capacity (size) of every extent is identical.

In this configuration, the range of offset addresses (offset position from the beginning address) of logical extents is identical to the range of offset addresses of associated physical extents. For example, in the configuration exemplified in FIG. 4, a logical extent L-Ext0 is associated with a physical extent P-Ext0. In this case, both offset addresses 0 and 1 in the logical extent L-Ext0 correspond to offset addresses 0 and 1 in the physical extent P-Ext0, respectively. In other words, an access to the offset address 1 in the logical extent L-Ext0 is equivalent to an access to the offset address 1 in the physical extent P-Ext0.

Next, another configuration, exemplified in FIG. 5, for which the above-described multi-extent is defined, will be described. In the configuration exemplified in FIG. 5, logical extents (L-Ext0 and L-Ext1 in FIG. 5) composing the multi-extent 304 are associated with physical extents (P-Ext0 and P-Ext1 in FIG. 5) each belonging to a different redundancy group (e.g. redundancy groups 0 and 1 exemplified in FIG. 3) in a distributed manner.

In the configuration exemplified in FIG. 5, the logical extent L-Ext0 composing the multi-extent is, for each specific address range in the logical extent, associated with a specific address range in the physical extent P-Ext0, associated with the logical extent L-Ext0. Also, the logical extent L-Ext0 is, for each specific address range in the logical extent, associated with a specific address range in the physical extent P-Ext1 which is associated with the logical extent L-Ext1 which also composes the multi-extent. In other words, the logical extent L-Ext0 is associated with the physical extent P-Ext0 and the physical extent P-Ext1 in a distributed manner.

Specifically, the offset address 0 in the logical extent L-Ext0 is associated with the offset address 0 in the physical extent P-Ext0. The offset address 1 in the logical extent L-Ext0 is associated with the offset address 0 in the physical extent P-Ext1, which is associated with the logical extent L-Ext1, which composes the multi-extent with the logical extent L-Ext0.

Accordingly, an access to the offset address 1 in the logical extent L-Ext0 is equivalent to an access to the offset address 0 in the physical extent P-Ext1.

As described above, an access to a logical extent composing a multi-extent, which are applied in the first exemplary embodiment, is distributed over a plurality of physical extents. With this configuration, data are striped between a plurality of logical extents composing the multi-extent and physical extents individually associated with the plurality of logical extents.

In this case, it may be understood that a configuration of RAID level 0 (hereinafter, may be simply referred to as RAID 0) is virtually implemented between logical extents composing a multi-extent and physical extents associated with the logical extents.

As described above, for the storage controller 102 of the first exemplary embodiment, a multi-extent configured by a plurality of logical extents are defined and applied. With this configuration, the storage controller 102 is able to distribute an access to logical extents composing a multi-extent over physical extents belonging to different redundancy groups.

According to the storage apparatus 100 of the first exemplary embodiment described above, the storage controller 102, for example, configures a multi-extent (e.g. multi-extent 304 exemplified in FIG. 3) by assembling consecutively arranged logical extents (e.g. logical extents 302 and 303 exemplified in FIG. 3), which are associated with physical extents (e.g. physical extents 305 and 307 exemplified in FIG. 3) belonging to a plurality of different redundancy groups (e.g. redundancy groups 0 and 1 exemplified in FIG. 3). The storage apparatus 100 can provide the host machine 101 with a logical disk (e.g. logical disk 301 exemplified in FIG. 3) including the multi-extent as a storage space.

With this configuration, the storage controller 102 makes it possible to distribute (separate) an access request to a space configured with multi-extent from the host machine 101 to accesses to physical extents belonging to different redundancy groups.

As described above, the storage apparatus 100 according to the first exemplary embodiment makes it possible to distribute an access to specific data by the host machine 101 over storage devices arranged in a plurality of different redundancy groups. Accordingly, the storage apparatus 100 according to the first exemplary embodiment has an advantageous effect of making it possible to reduce a load on specific storage devices and improve access performance.

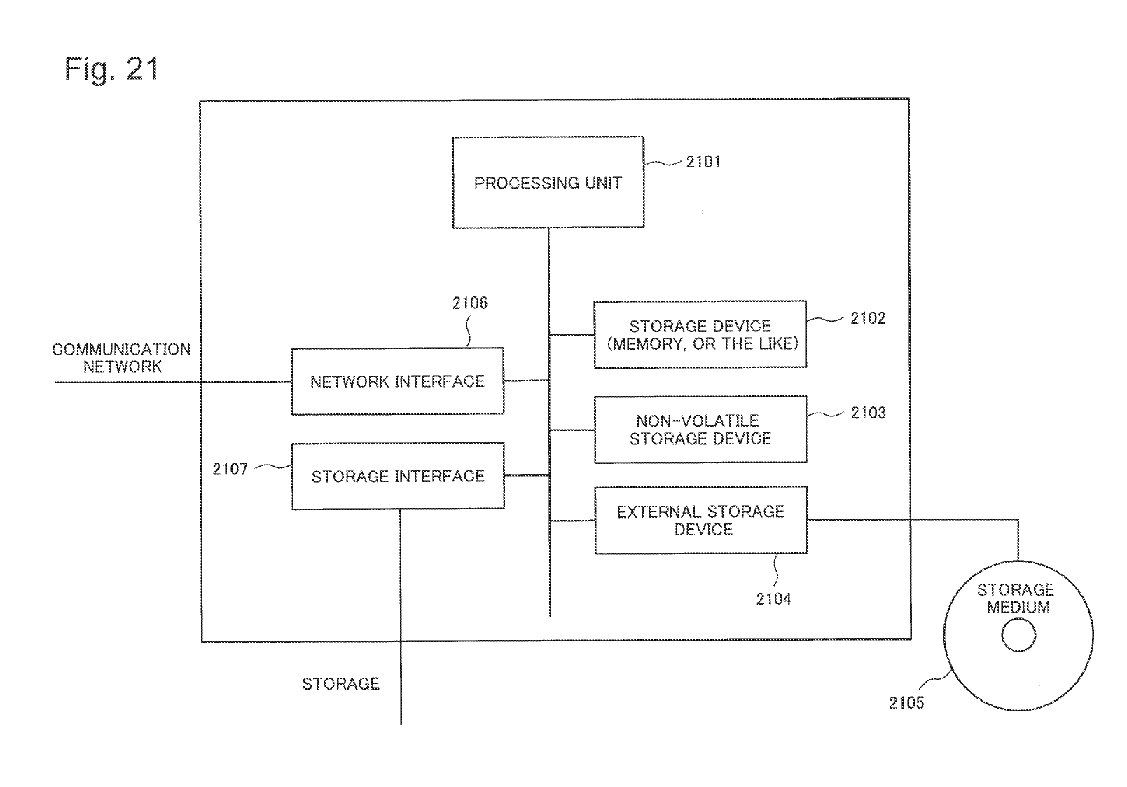

The storage controller 102 of the first exemplary embodiment may be configured with independent dedicated hardware. The storage controller 102 may also be configured with hardware including an processing unit 2101 such as a general-purpose CPU (Central Processing Unit) and a microprocessor exemplified in FIG. 21, a storage device 2102 such as memories to which the processing unit refers, and so on, and various software programs (computer programs) which are executed by the processing unit 2101.

The above-described software programs may be stored in an external recording medium 2105. In this case, the above-described software programs, stored in an external recording medium 2105, are appropriately stored in a non-volatile memory 2103 via an external storage device 2104 in a shipping phase, operation phase, or the like of the storage apparatus 100.

Moreover, the storage controller 102 of the first exemplary embodiment may be configured to be connected to a communication network by a network interface 2106 and to be connected to the host machine 101 via the communication network. Furthermore, the storage controller 102 may be configured to be connected to the storage device group 103 by a storage interface 2107.

### Second Exemplary Embodiment

Next, a second exemplary embodiment of the present invention will be described. In the following description, characteristic configuration regarding the second exemplary embodiment will be mainly described. In the description, the same reference numeral are given to the same elements as in the above-described first exemplary embodiment, and thus duplicate description will be avoided.

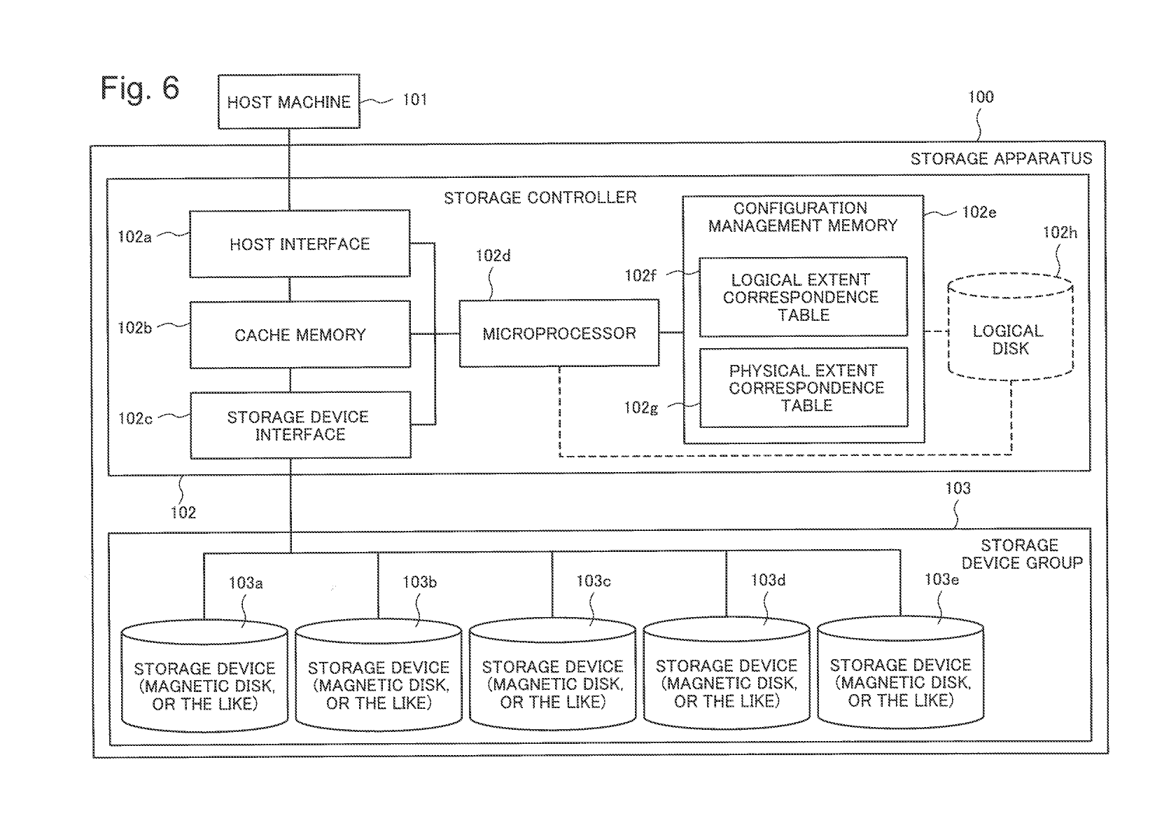

A storage apparatus 100 of the second exemplary embodiment has a similar basic configuration to the storage apparatus 100 of the above-described first exemplary embodiment. Referring to FIG. 6, a structure of a storage controller 102, which is a characteristic element in the second exemplary embodiment, will be mainly described below.

The storage controller 102 of the second exemplary embodiment includes a host interface 102a, which is a connection interface to a host machine 101. The storage controller 102 also includes a cache memory 102b configured to temporarily store data exchanged between the host machine 101 and a storage device group 103. The storage controller 102 also includes a storage device interface 102c connected to the storage device group 103. The storage controller 102 also includes a microprocessor 102d configured to carry out various processing and control in the storage controller 102. The storage controller 102 also includes a configuration management memory 102e configured to store association information between logical extents composing a logical disk and physical extents, or the like. Each element will be described below.

The host interface 102a is communicably connected to the host machine 101. The host interface 102a provides the host machine 101 with an interface to the storage apparatus 100 and transmits and receives data with the host machine 101. For example, as a communication method between the host interface 102a and host machine 101, a well-known storage connection technology such as FB and iSCSI may be employed so as to configure a SAN, as described above.

The cache memory 102b is, in general, configured with a semiconductor storage device or the like, which has faster access speed than the storage device group 103 and temporarily stores data accessed by the host machine 101. The cache memory 102b may, for example, record data which are accessed once by the host machine 101. When the host machine 101 accesses (refers to) the same data again, the storage controller 102 can increase an apparent access speed by providing the data stored in the cache memory 102b.

In the second exemplary embodiment, however, necessity of the cache memory 102b (whether implementing cache memory 102 or not), a memory capacity of the cache memory 102b, and so on may be determined appropriately based on access performance or the like required for a storage controller 102.

The storage device interface 102c is communicably connected to storage devices 103a to 103e. The storage device interface 102c may transmit and receive (read and write) data with each storage device, by using the well-known data access interface described in the above-described first exemplary embodiment.

The microprocessor 102d is a control device configured to control operations of the storage controller of the second exemplary embodiment. The microprocessor 102d may be configured with dedicated control hardware, in which control logic for controlling the storage apparatus 100 is implemented. The microprocessor 102d may also be configured with a general-purpose processing unit, and a general-purpose memory (not illustrated), which is referred to by the processing unit, and so on, as described above.

When the microprocessor 102d is configured with a general-purpose processing unit, the microprocessor 102d controls operations of the storage apparatus 100 by executing a software program to control the storage apparatus 100.

The configuration management memory 102e is a storage space configured to store information about associations between logical extents composing a multi-extent, which are described in the first exemplary embodiment, and associations between logical extents and physical extents. The configuration management memory 102e may include, for example, a logical extent correspondence table 102f and a physical extent correspondence table 102g. The configuration management memory 102e may be contained in a non-volatile readable-and-writable semiconductor storage device. For example, the configuration management memory 102e may be loaded onto a memory, which is accessible for the microprocessor 102d, when the storage apparatus 100 is in operation.

As in the first exemplary embodiment, the storage controller 102 provides the host machine 101 with a logical disk as a storage space. The reference numeral 102h in FIG. 6 refers to the logical disk exemplarily.

In response to an access request from the host machine 101, the microprocessor 102d configures the logical disk 102h by using data in the configuration management memory 102e or the like. And the microprocessor 102d provides the host machine 101, which is the source of the access request, with the configured logical disk 102h. In the second exemplary embodiment, the logical disk 102h may be set up as a portion of the configuration management memory 102e or may be set up in a not-illustrated memory space accessible for the microprocessor 102d.

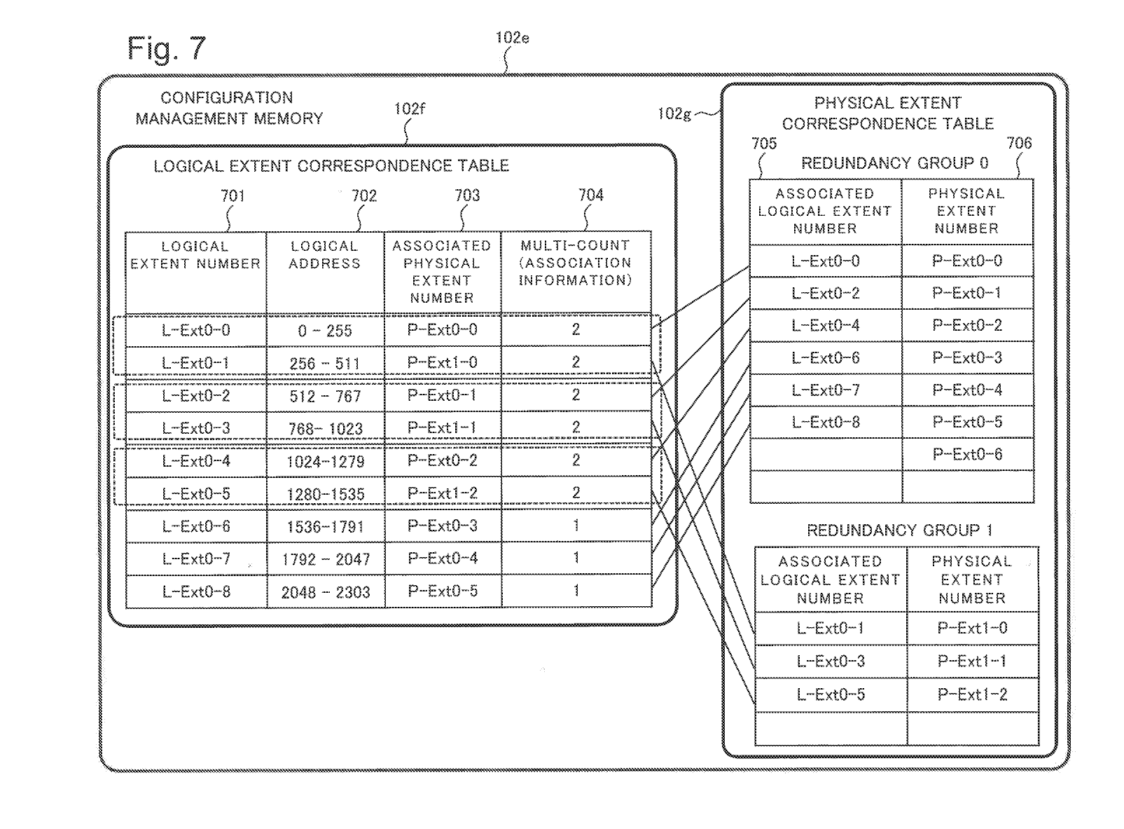

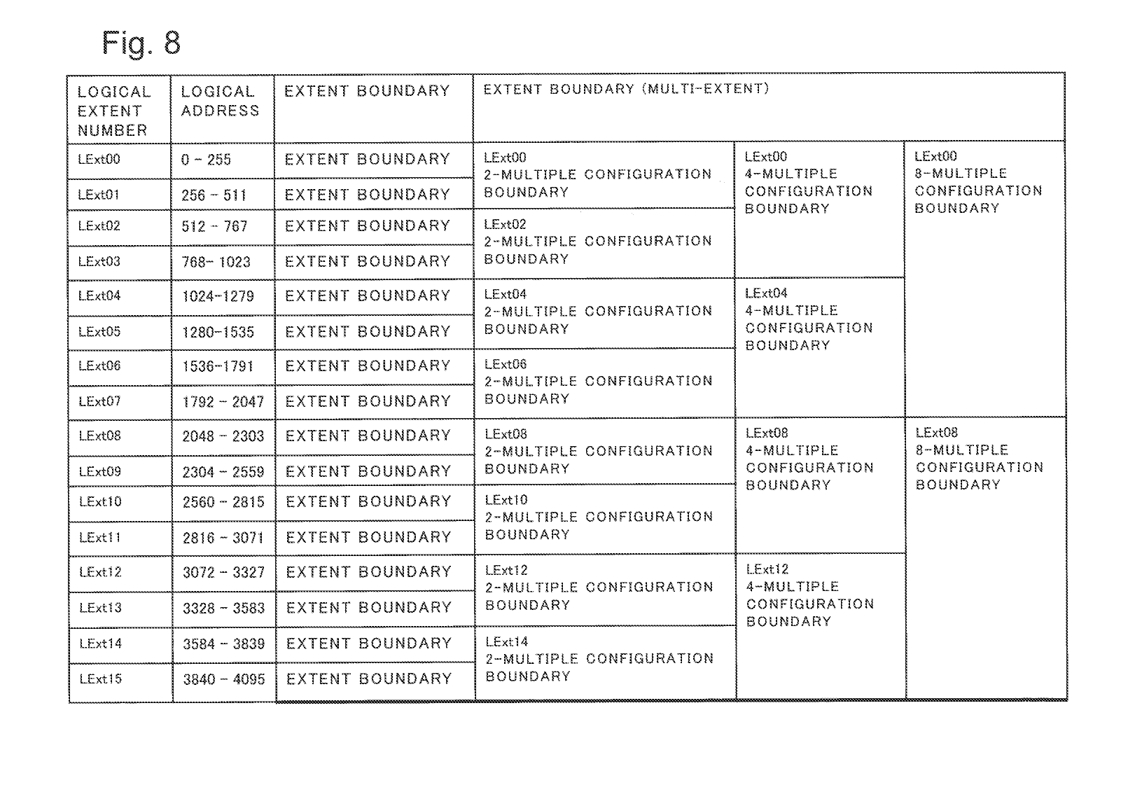

Referring to FIGS. 7 and 8 as a specific example, a configuration of the configuration management memory 102e of the second exemplary embodiment will be described below.

FIG. 7 is an exemplary diagram illustrating an example of the configuration management memory 102e of the second exemplary embodiment. As illustrated in FIG. 7, the logical extent correspondence table 102f composing the configuration management memory 102e includes a logical extent number (701 in FIG. 7), a logical address (702 in FIG. 7), an associated physical extent number (703 in FIG. 7), and a multi-count (704 in FIG. 7).

The logical extent number (701 in FIG. 7) is an identification number by which a logical extent (e.g. logical extents 302, 303, and so on exemplified in FIG. 3) composing a logical disk (e.g. logical disk 301 exemplified in FIG. 3) provided by the storage apparatus 100 can be uniquely identified.

The logical address (702 in FIG. 7) is an address assigned to each logical extent in the logical disk.

The associated physical extent number (703 in FIG. 7) is a number by which a physical extent associated with each logical extent is referred to.

The multi-count (704 in FIG. 7) is information by which logical extents composing multi-extent are linked (associated) together.

The physical extent correspondence table 102g includes a physical extent number (706 in FIG. 7) and an associated logical extent number (705 in FIG. 7).

The physical extent number (706 in FIG. 7) is a number by which a physical extent belonging to each redundancy group (e.g. redundancy group 0, redundancy group 1, and so on, exemplified in FIG. 3) can be uniquely identified.

The associated logical extent number (705 in FIG. 7) is a number by which a logical extent associated with a physical extent identified by a physical extent number (706 in FIG. 7) is referred to.

As in the first exemplary embodiment, the storage controller 102 configures a logical disk as a set of logical extents. The storage controller 102 selects unused physical extents from one or more redundancy groups, and associates logical extents composing the logical disk with the selected physical extents. Methods to configure a multi-extent and to associate a logical extent with a physical extent of the second exemplary embodiment will be described below.

When a plurality of redundancy groups exist in the above-described pool and unused physical extents are provided by each different redundancy group, the storage controller 102 associates logical extents composing the above-described logical disk with the physical extents in order.

The storage controller 102 of the second exemplary embodiment configures a multi-extent by assembling logical extents associated with physical extents belonging to different redundancy groups.

An example configuration of a multi-extent of the second exemplary embodiment will be described with reference to FIG. 8. FIG. 8 is an exemplary diagram illustrating an example of configurations which are employable as multi-extent of the second exemplary embodiment. FIG. 8 exemplifies boundaries of multi-extent arranged on a logical disk, when it is assumed that the minimal number (hereinafter, may be referred to as “base value”) of logical extents composing a multi-extent is 2, in the second exemplary embodiment.

The storage controller 102 selects logical extents arranged at boundaries of which an address is a product of the base value (“2”) and a power of 2, in order from the beginning address of the logical disk, when the above-described base value is assumed to be 2. The storage controller 102 then configures a multi-extent by assembling a number of power of 2 logical extents, beginning from the selected logical extents.

Referring to FIG. 8, for example, when multi-extent are configured by using two (computed as “(the base values of 2)*(the 0th power of 2, which is equal to 1)=2”, hereafter the symbol “*” denotes multiplication, and the symbol “=” denotes equality) logical extents, a beginning extent of each of the multi-extent has a logical extent number of LExt00, LExt02, LExt04, LExt06, LExt08, LExt10, LExt12, or LExt14. These logical extents are arranged, in order from the beginning address (LExt00), at boundaries the addresses of which are multiples of a product (2 in this case) of the base value of 2 and a power of 2.

Similarly, when multi-extent are configured by using four (computed as “(the base value of 2)*(the first power of 2, which is equal to 2)=4”) logical extents, a beginning extent of each of the multi-extent has a logical extent number of LExt000, LExt04, LExt08, or LExt12. When multi-extent are configured by using eight (computed as “(the base value of 2)*(the second power of 2, which is equal to 4)=8”) logical extents, a beginning extent of each of the multi-extent has a logical extent number of LExt00 or LExt08.

FIG. 8 exemplifies a case in which a logical disk is configured by using sixteen logical extents, the logical extent numbers of which are up to LExt15. A logical disk configured by more than sixteen logical extents can be configured in a similar manner.

As described above, the storage controller 102 associates logical extents composing a multi-extent with physical extents each belong to a different redundancy group.

In the second exemplary embodiment, in order to configure multi-extent as illustrated in FIG. 8, the storage controller 102 sets a product of the base value of 2 and a power of 2 as the multi-count (704 in FIG. 7). The storage controller 102 acquires unused physical extents from different redundancy groups, the number of which corresponds to the multi-count. The storage controller 102 configures a multi-extent by assembling logical extents associated with the physical extents, when unused physical extents are able to be acquired. In the other word, The storage controller 102 configures a multi-extent by assembling logical extents, when unused physical extents, of the number same to the multi-count, are acquirable.

In the second exemplary embodiment, the above-described multi-count is used as association information by which a plurality of logical extents composing a specific multi-extent are linked together. To the multi-counts of logical extents composing a specific multi-extent, an identical value is set.

In the configuration exemplified in FIG. 8, for example, for the storage controller 102 is able to link (associate) together the logical extents LExt00 and LExt01 by using a multi-count of 2. However, the storage controller 102 does not link together the logical extents LExt1 and LExt2 by using the multi-count of 2 (i.e. these logical extents do not compose a multi-extent with a multi-count of 2). This is because the logical extents LExt1 and LExt2 have, therebetween, a boundary of a multi-extent with a multi-count of 2 (computed as “(the base value of 2)*(the 0th power of 2)”, and it is equal to 2 in this case). In the other words, the logical extents LExt1 and LExt2 are disposed to across the boundary of the multi-extent.

Similarly, the storage controller 102 is able to link together the logical extents LExt00 to LExt03 by using a multi-count of 4. However, the storage controller 102 does not link together, for example, logical extents LExt02 to LExt05, or LExt03 to LExt06 by using the multi-count of 4.

When the multi-count of the logical extent LExt00 is 2, the multi-count of the logical extent LExt01 is also 2. Similarly, when the multi-count of the logical extent LExt01 is 4, all of the multi-counts of the logical extents LExt00 to LExt03 are 4. When the multi-count is 8, 16, and 32, an identical value is set to the multi-counts associated to a plurality of logical extents composing specific multi-extent in a similar manner, respectively.

Referring to FIG. 7, an area (704 in FIG. 7) to store a multi-count for each logical extent number 701 is included in the logical extent correspondence table 102f. In the configuration exemplified in FIG. 7, the logical extent L-Ext0-0 in the logical disk is associated with the physical extent P-Ext0-0 in the redundancy group 0. The logical extent L-Ext0-1 is associated with the physical extent P-Ext1-0 in the redundancy group 1.

The logical extent L-Ext0-0 is the beginning extent (first position) of the logical disk, and the consecutive logical extents L-Ext0-0 and L-Ext0-1 are associated with physical extents in different redundancy groups. Hence, the number “2” is set as multi-count for the logical extents L-Ext0-0 and L-Ext0-1.

Similarly, the logical extent L-Ext0-2 is associated with the physical extent P-Ext0-1 in the redundancy group 0, and the logical extent L-Ext0-3 is associated with the physical extent P-Ext1-1 in the redundancy group 1.

The logical extent L-Ext0-2 is arranged at the second position from the beginning extent in the logical disk (at a boundary with a value of a product of the base value of 2 and a power of 2). The consecutive logical extents L-Ext0-2 and L-Ext0-3 are associated with physical extents in different redundancy groups. The number “2” is set as multi-count for the logical extents L-Ext0-2 and L-Ext0-3.

The number of multi-counts are similarly set for the logical extents L-Ext00-4 and L-Ext0-5.

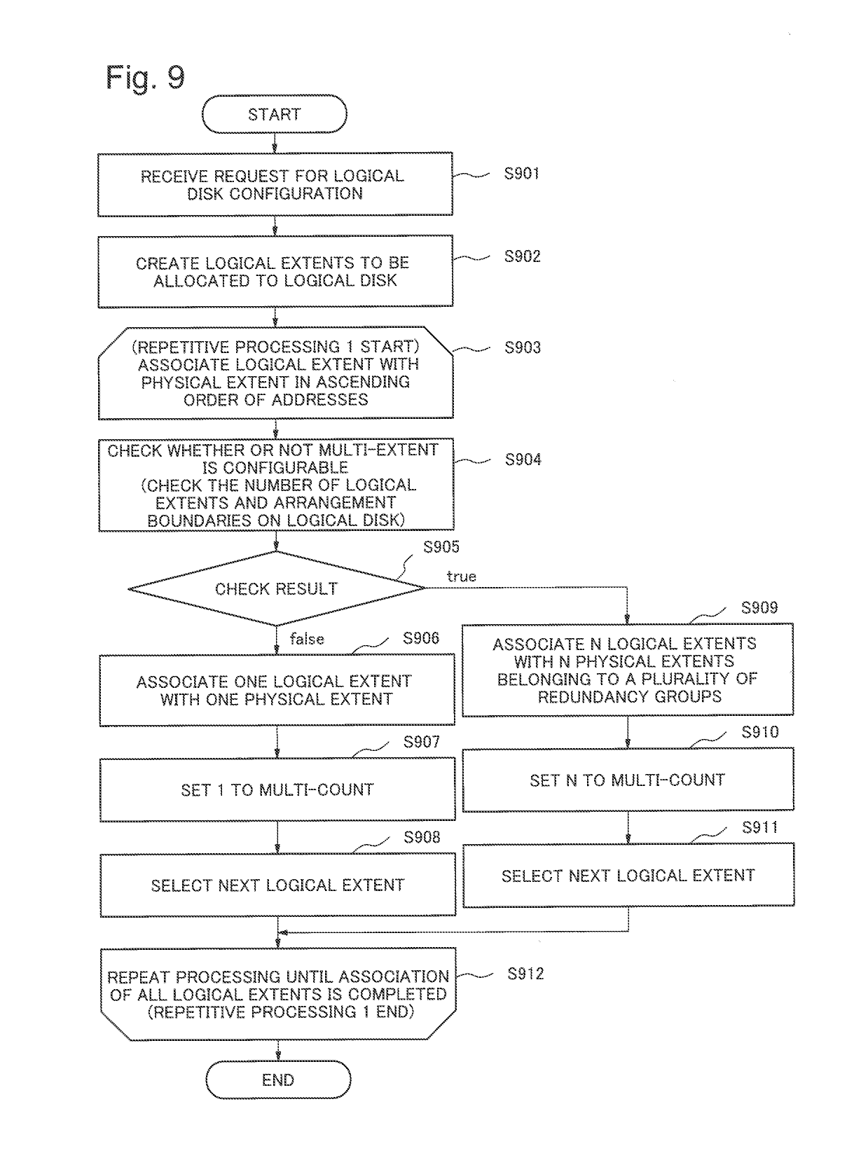

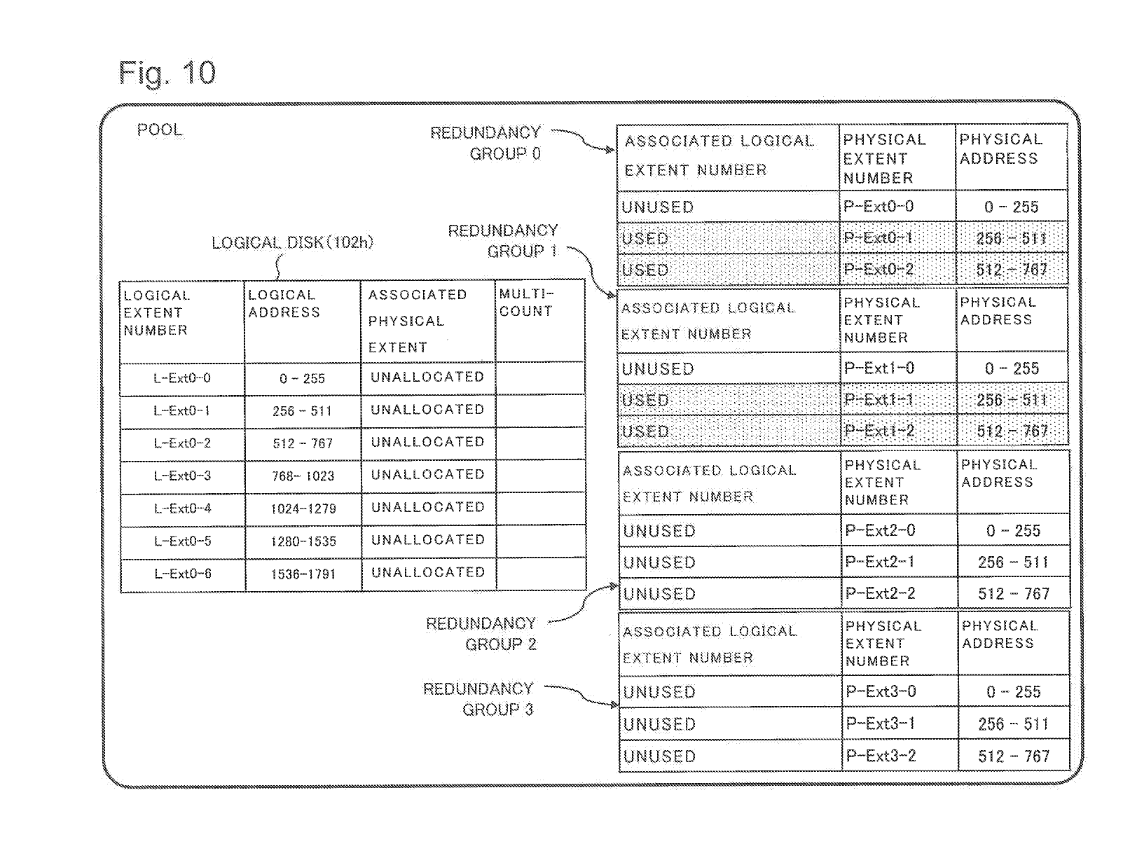

Next, configuration procedures of a logical disk, which includes multi-extent of the above-described second exemplary embodiment, carried out by the storage controller 102 of the second exemplary embodiment will be described with reference to FIGS. 9 to 13. FIG. 9 is a flowchart illustrating an example of procedures to configure a logical disk including multi-extent of the second exemplary embodiment. FIGS. 10 to 13 are exemplary diagrams illustrating an example of the procedures to configure the logical disk.

In the following description, as exemplified in FIGS. 10 to 13, a case, in which four redundancy groups (redundancy groups 0, 1, 2, and 3) are provided in the above-described pool, will be described as an illustrative example of the second exemplary embodiment. Specifically, the redundancy group 0 includes one unused physical extent, the redundancy group 1 includes one unused physical extent, the redundancy group 2 includes three unused physical extents, and the redundancy group 3 includes three unused physical extents.

In the following illustrative example, the storage controller 102 configures a logical disk with a capacity for containing seven logical extents. In the following illustrative example, it is assumed that the sizes of a logical extent and a physical extent are both 256 KiB (1 KiB=1024 bytes). It is assumed that a unit address range, in which data are distributed between a plurality of logical extents composing multi-extent and physical extents each associated with one of the logical extents, is 1 KiB. The unit address range is a unit of striping (of virtual RAID 0), which was described in the first exemplary embodiment. It is also assumed that the number (base value) of logical extents composing multi-extent is 2.

The size of a logical extent and a physical extent and the size of a unit of striping, which was described in the first exemplary embodiment above, are not limited to the values exemplified above. Arbitrary proper values may be appropriately adopted as these sizes based on a specification or the like for the storage apparatus is required to conform to. For example, the size of an extent may be 256 MB (Mega Byte), and the size of striping may be 1 MB.

First, configuration processing (procedures) of a logical disk, which is provided to the host machine 101, will be described. The storage controller 102 receives a request for configuration of the logical disk 102h from the host machine 101 (step S901 in FIG. 9).

The storage controller 102 analyzes the request for configuration of the logical disk described above. The storage controller 102 creates logical extents to be allocated to the logical disk 102h in accordance with a logical capacity (storage capacity provided to the host machine 101 as a logical disk), which is considered necessary (step S902).

In the illustrative example illustrated in FIG. 10, the storage controller 102 creates seven logical extents with logical extent numbers of L-Ext0-0 to L-Ext0-6, to be allocated to the logical disk 102h.

Next, the storage controller 102 associates each logical extent composing the logical disk 102h with a physical extent in ascending order of logical addresses in the logical disk 102h (steps S903 to S912).

First, the storage controller 102 checks whether or not it is possible to configure a multi-extent with respect to a logical extent composing the logical disk 102h (step S904). Processing that determines whether a multi-extent is configurable or not will be described below.

The storage controller 102 selects a beginning (first) logical extent composing the logical disk, and checks a boundary condition whether a multi-extent is configurable or not. In the illustrative example illustrated in FIG. 10, the beginning logical extent L-Ext0-0 is able to be selected as a beginning extent of multi-extent with a multi-count of 2, 4, 8, and so on. The storage controller 102 determines the multi-count with which a multi-extent can be configured based on the boundary conditions exemplified in FIG. 8.

Next, the storage controller 102 checks whether or not it is possible to acquire an unused physical extent from each of the redundancy groups 0 to 3 included in the pool. The storage controller 102 determines whether or not it is possible to configure a multi-extent with a multi-count less than or equal to the number of redundancy groups from which unused physical extents can be acquired. When a multi-extent is configurable, the storage controller 102 associates a plurality of logical extents composing the multi-extent with unused physical extents each provided from a different redundancy group, and sets a multi-count. In the illustrative example illustrated in FIG. 10, the storage controller 102 is able to acquire an unused physical extent from each of the redundancy groups 0 to 3. The storage controller 102 thus determines that it is possible to configure multi-extent with a multi-count of 4 (“true” in step S905).

In this case, the storage controller 102 associates a plurality of logical extents composing the multi-extent with physical extents each belong to a different redundancy group (step S909).

In the illustrative example illustrated in FIG. 10, the storage controller 102 associates four logical extents L-Ext0-0, L-Ext0-1, L-Ext0-2, and L-Ext0-3, (which include the beginning logical extent L-Ext0-0 of the logical disk 102h,) with physical extents P-Ext0-0, P-Ext1-0, P-Ext2-0, and P-Ext3-0, each of which belongs to a different redundancy group, respectively.

Next, the storage controller 102 sets a multi-count, which is associated to each logical extent (step S910). In the illustrative example illustrated in FIG. 10, the storage controller 102 sets 4 to the multi-counts.

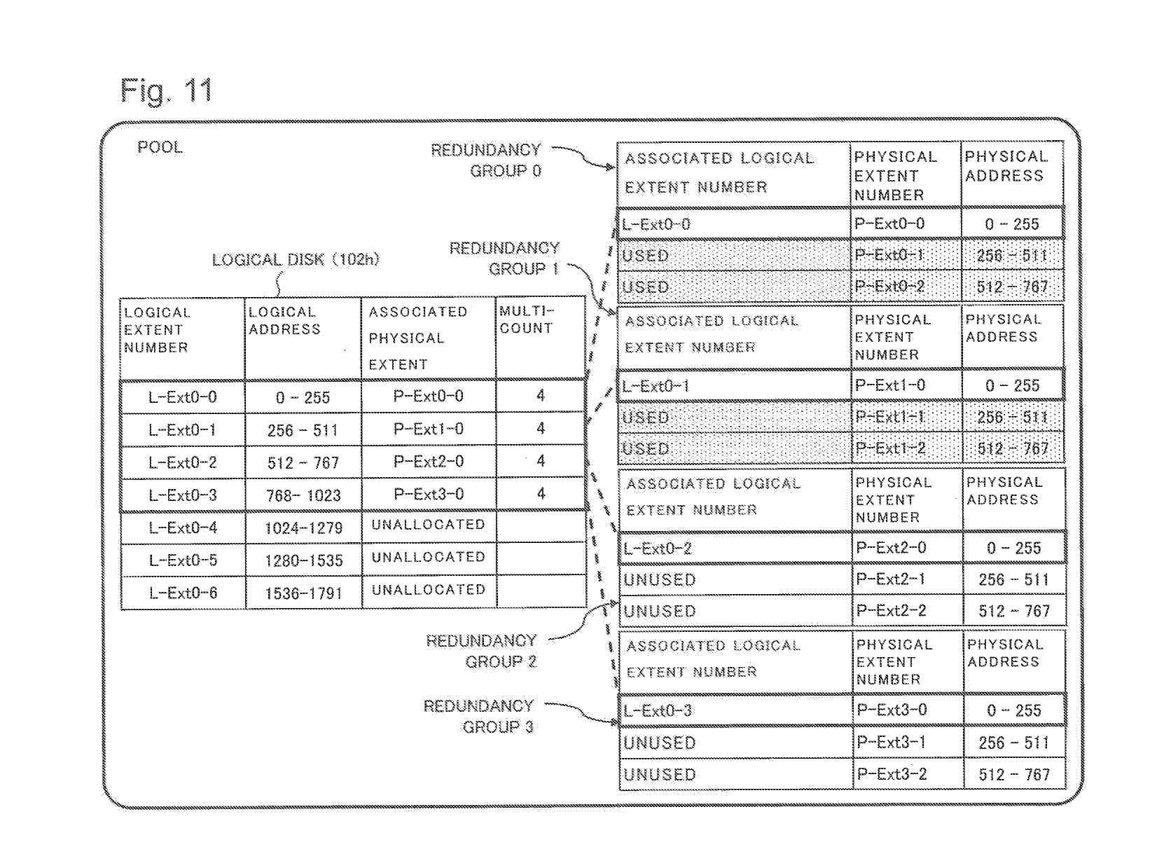

The storage controller 102 updates the logical extent correspondence table 102f and physical extent correspondence table 102g8, by using the information on the associations in the above-described step S909 and the information on the multi-count in step S910. As a result of the processing above, the logical disk 102h in the illustrative example of the second exemplary embodiment has a configuration as illustrated in FIG. 11.

Next, the storage controller 102 selects a next logical extent which is not associated with a physical extent yet and composes the logical disk 102h (step S911). In the illustrative example illustrated in FIG. 11, the first logical extent which is not associated with any physical extent is a logical extent L-Ext0-4. The storage controller 102 continues processing for the logical extent L-Ext0-4 from step S904.

The storage controller 102 checks whether or not multi-extent are configurable with regard to the logical extent L-Ext0-4 (step S905). Referring to FIG. 8, the logical extent L-Ext0-4 may be a boundary (beginning element) of a multi-extent with a multi-count of 2 or 4. The storage controller 102 determines the multi-count with which a multi-extent is configurable based on the boundary conditions exemplified in FIG. 8.

Next, the storage controller 102 checks whether or not it is possible to acquire an unused physical extent from each of the redundancy groups 0 to 3 included in the pool. Referring to FIG. 11, an unused physical extent may be selected from each of the redundancy groups 2 and 3. The storage controller 102 thus determines that a multi-extent with a multi-count of 2 are configurable (“true” in step S905).

In this case, the storage controller 102 associates a plurality of logical extents composing the multi-extent with physical extents each belong to a different redundancy group (step S909). In the illustrative example exemplified in FIG. 11, the storage controller 102 associates two logical extents L-Ext0-4 and L-Ext0-5 with physical extents P-Ext2-1 and P-Ext3-1 each belonging to a different redundancy group.

Next, the storage controller 102 sets a multi-count associated to each of the logical extents (step S910). In the illustrative example illustrated in FIG. 10, the storage controller 102 sets 2 to the multi-counts for L-Ext0-4 and L-Ext0-5.

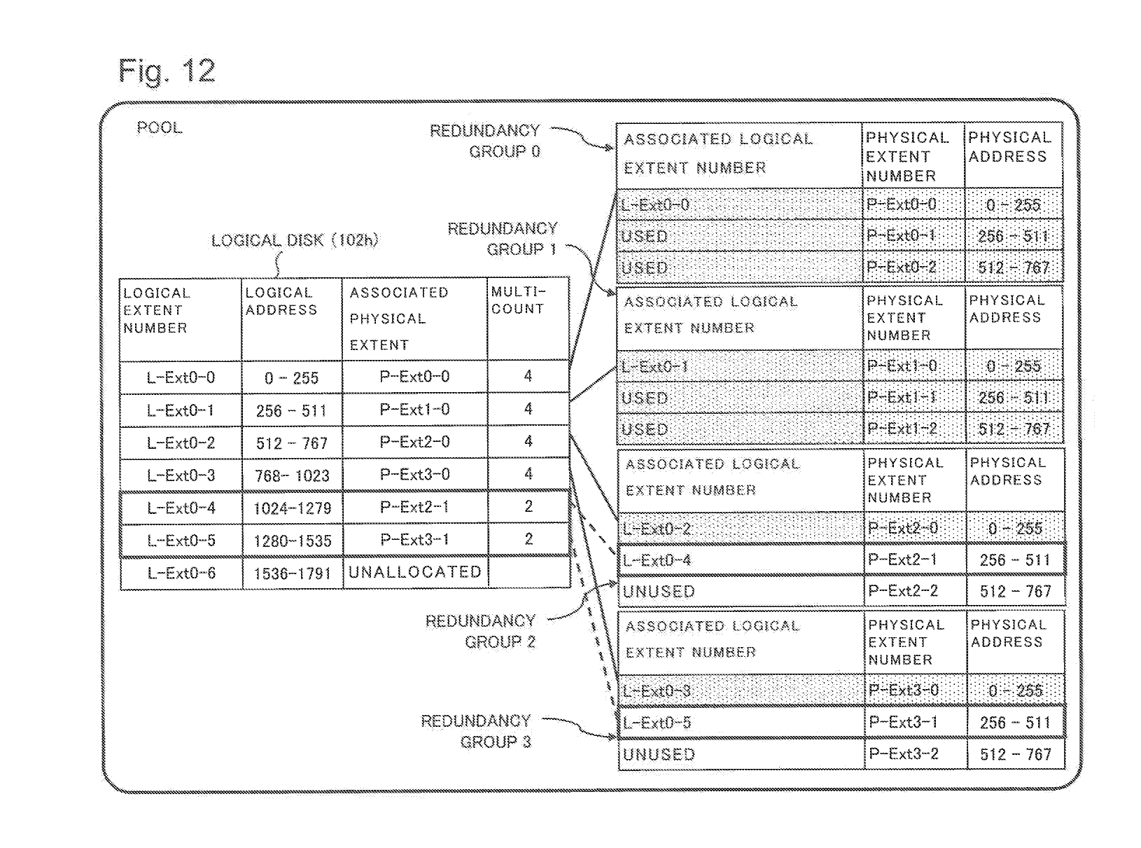

The storage controller 102 updates the logical extent correspondence table 102f and the physical extent correspondence table 102g, by using information on the associations in the above-described step S909 and information on the multi-count in step S910. As a result of the above processing, the logical disk 102h in the illustrative example of the second exemplary embodiment has a configuration as illustrated in FIG. 12.

Next, the storage controller 102 selects a next logical extent which is not associated with any physical extent yet and composes the logical disk 102h (step S911). In the illustrative example illustrated in FIG. 12, the logical extent not associated with a physical extent is a logical extent L-Ext0-6. The storage controller 102 continues processing for the logical extent L-Ext0-6 from step S904.

The storage controller 102 checks whether or not a multi-extent is configurable with regard to the logical extent L-Ext0-6 (step S905). Because the remaining logical extent that needs to be associated with a physical extent is only the logical extent L-Ext0-6, the storage controller 102 determines that no multi-extent is configured (“false” in step S905).

Next, the storage controller 102 selects an unused physical extent belonging to either redundancy group, and associates the logical extent with the selected physical extent (step S906). In the illustrative example exemplified in FIG. 12, the storage controller 102 associates the logical extent L-Ext0-6 with a physical extent P-Ext2-2.

Next, the storage controller 102 sets 1 to the multi-count associated to the logical extent (step S907). In the illustrative example illustrated in FIG. 12, the storage controller 102 sets 1 to the multi-count corresponding to the logical extent L-Ext0-6.

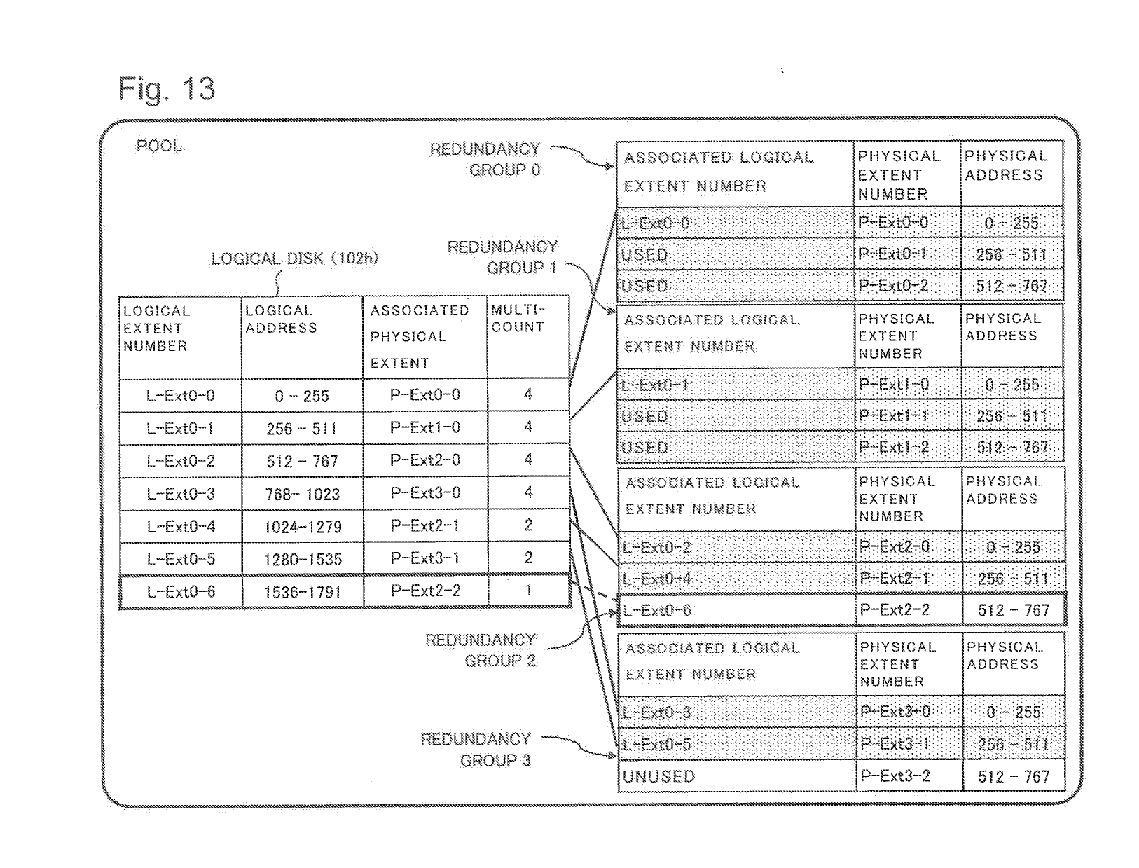

The storage controller 102 may update the logical extent correspondence table 102f and the physical extent correspondence table 102g, by using information on the association in the above-described step S906 and information on the multi-count in step S907. As a result of the above-described processing, the logical disk 102h in the illustrative example of the second exemplary embodiment has a configuration as illustrated in FIG. 13.

With the processing described above, association of all logical extents composing the logical disk 102h with physical extents is completed (step S912), the storage controller 102 finishes the configuration processing of the logical disk.

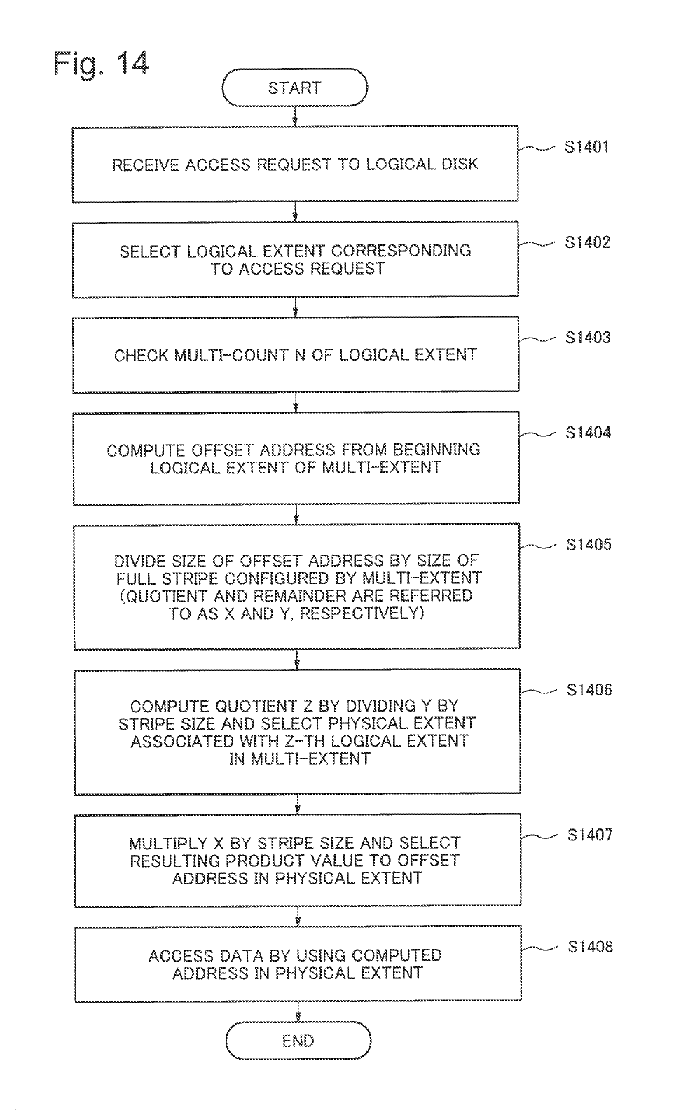

Next, a process to handle a request received from the host machine 101 to access the logical disk 102h configured as described above will be described with reference to FIG. 14. FIG. 14 is a flowchart illustrating an example of processing (procedures) in which, when an access request from the host machine 101 to the logical disk 102h is received, a physical address, at which data corresponding to the request are stored, is determined.

In the following description, the determination processing will be described by using the illustrative example illustrated in FIG. 13 and an example case in which a logical address (address at which data is stored in the logical disk 102h) of 258 is accessed by the host machine 101. In the second exemplary embodiment, an access request, from the host machine 101 to specific data, includes a read or write request or the like, to the specific data space (data region).

First, the storage controller 102 receives an access request from the host machine 101 to a specific address space in the logical disk 102h (step S1401).

Next, the storage controller 102 analyzes the access request and, based on a logical address specified as an access target, selects a logical extent including the space specified by the logical address (step S1402). For example, in the illustrative example illustrated in FIG. 13, the logical extent that includes the logical address of 258 is the logical extent L-Ext0-1.

Next, the storage controller 102 checks the multi-count (4 in this case) of the logical extent L-Ext0-1 (step S1403).

Next, the storage controller 102, referring to boundary conditions of multi-extent, selects a beginning logical extent composing the multi-extent defined by the multi-count of 4. The storage controller 102 then computes an offset address from the selected beginning extent (step S1404).

In the illustrative example exemplified in FIG. 13, because the beginning extent is the logical extent L-Ext0-0 and the beginning address of the extent is 0, the offset address from the beginning extent L-Ext0-0 is 258 (computed as “258-0=258”, hereafter, the symbol “−” denotes subtraction).

Next, the storage controller 102 computes a physical address in a physical extent based on the offset address in the logical extents computed in the above-described step S1404. Computation of the physical address will be described below.

The storage controller 102 first divides the offset address computed in the above-described step S1404 by the size of a full stripe defined over the multi-extent (step S1405).

In the above computation, the size of a full stripe is a product of the multi-count (4 in the illustrative example) and the size of the virtual striping (in the other word, size of virtual RAID 0 striping, that is 1 KiB in the illustrative example), which is configured between logical extents composing the multi-extent and associated physical extents. In this case, the size of a full stripe is 4 (computed as 4 multiplied by 1).

When the quotient and the remainder (residue), of the division of the above-described offset address of 258 by the above-described full stripe size of 4, are referred to as X and Y respectively, a computation result of X=64 and Y=2 is achieved.

Next, the storage controller 102 computes a quotient Z by dividing the above-described remainder Y by the stripe size. The storage controller 102 then selects a physical extent associated with a logical extent at the Z-th position from the beginning extent in the multi-extent (step S1406).

In the illustrative example exemplified in FIG. 13, the quotient Z of the division of the above-described remainder Y (=2) by the stripe size of 1 is 2. Because the second logical extent from the beginning extent L-Ext0-0 is the logical extent L-Ext0-2, the storage controller 102 selects the physical extent P-Ext2-0 associated with the logical extent.

Next, the storage controller 102 computes a product of the above-described quotient X and the stripe size. The storage controller 102 then sets the product value to the offset address in the above-described selected physical extent (address from the beginning address in the selected physical extent) (step S1407).

In the illustrative example exemplified in FIG. 13, the offset address is a 64 which is product of the above-described quotient X (=64) and the stripe size(=1). The storage controller 102 sets this value (64) to the offset address from the beginning address in the physical extent P-Ext2-0.

Next, the storage controller 102 carries out data access by using the computed physical address in the physical extent (step S1408).

When a data access in accordance with the method described above is carried out, as logical addresses of 0, 1, 2, 3, 4, 5, and so on are successively specified by the host machine 101, physical extents P-Ext0-0, P-Ext1-0, P-Ext2-0, P-Ext3-0, and P-Ext0-0 are selected in this order as the physical extents associated with the logical addresses.

Similarly, for logical extents L-Ext0-4 and L-Ext0-5, which are linked together so as to configure a multi-extent with a multi-count of 2, as logical addresses of 1024, 1025, 1026, and so on are successively specified, physical extents P-Ext2-1, P-Ext3-1, P-Ext2-1, and so on are selected interchangeably as the physical extents associated with the logical addresses.

In the case that a multi-count is 1, although one logical extent is associated with one physical extent, a physical address associated with a logical address is selectable by similar processing.

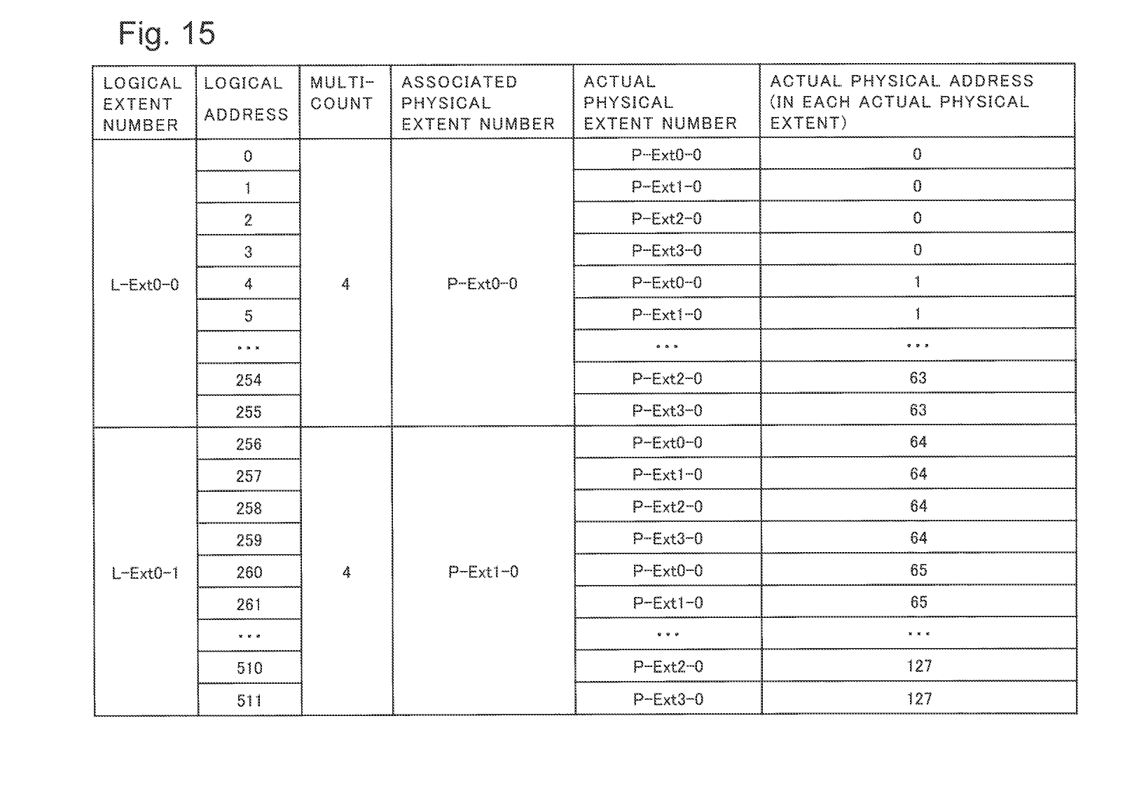

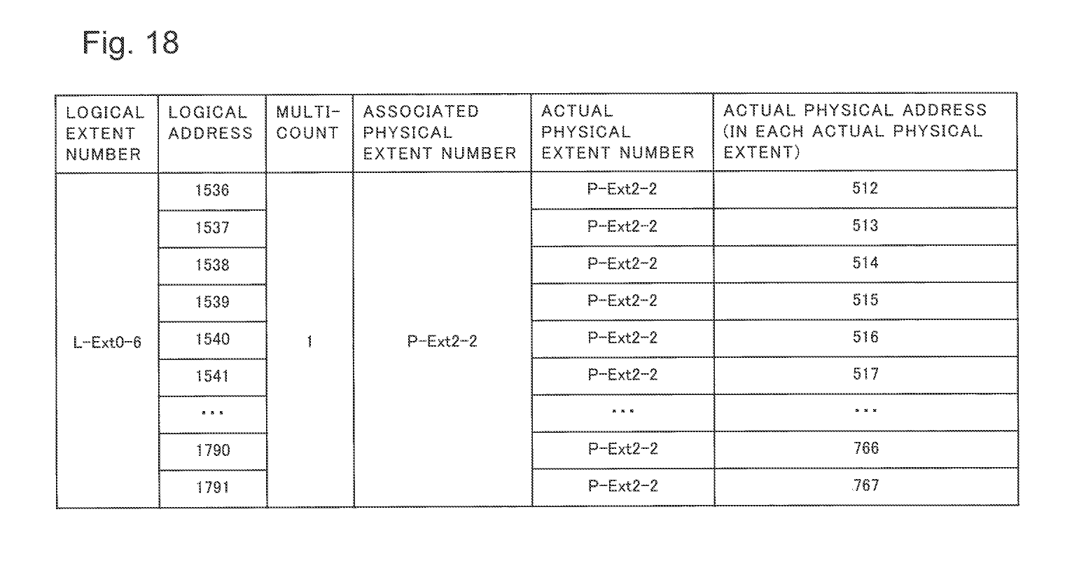

As described above, storage spaces composing multi-extent are distributed over a plurality of physical extents. Relations between logical addresses and physical addresses in the illustrative example described above are exemplified in FIGS. 15 to 18.

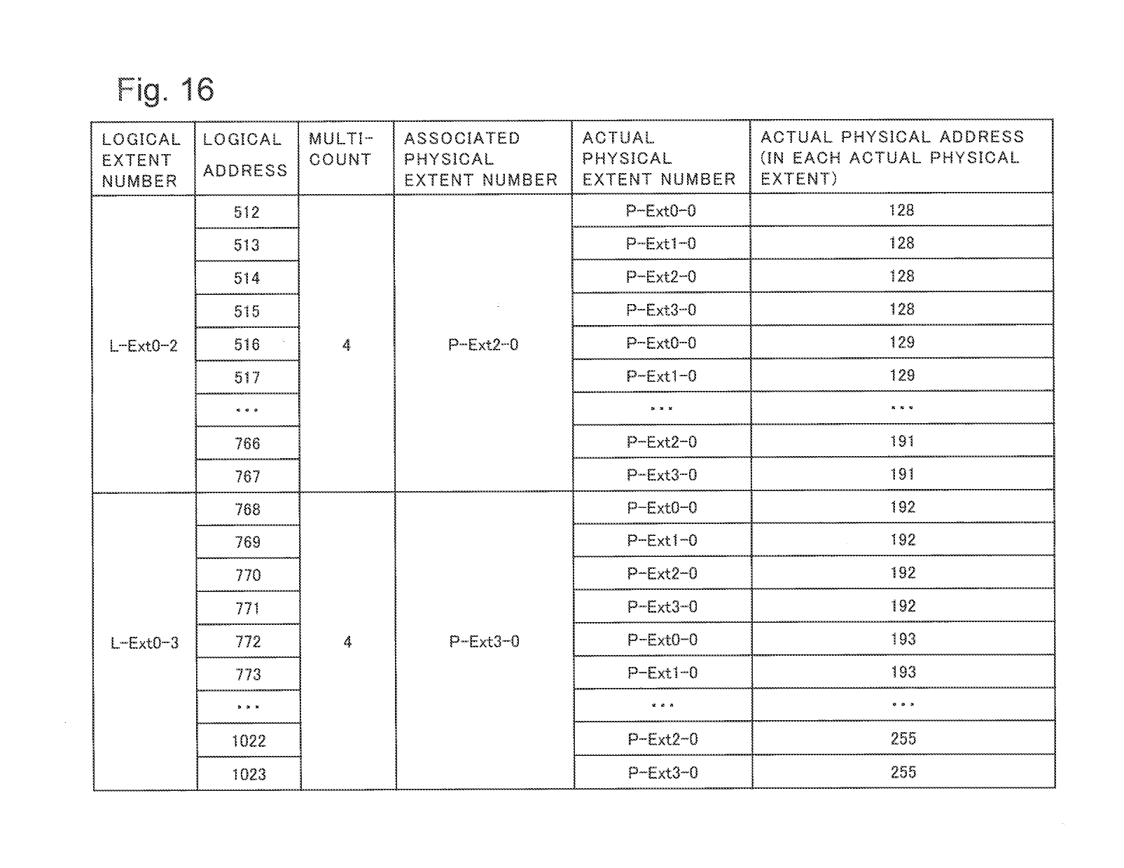

As illustrated in FIGS. 15 and 16, with each increase in the logical addresses of the logical extents L-Ext0-0, L-Ext0-1, L-Ext0-2, and L-Ext0-3, which are linked together with a multi-count of 4, an associated physical extent changes from P-Ext0-0 to P-Ext1-0, to P-Ext2-0, and to P-Ext3-0 in this order.

In other words, a logical address space produced by configuring a multi-extent with a multi-count of 4 is arranged in four different physical extents in a distributed manner for every logical address. With this configuration, an access to an address space specified by the logical address is striped over different physical extents.

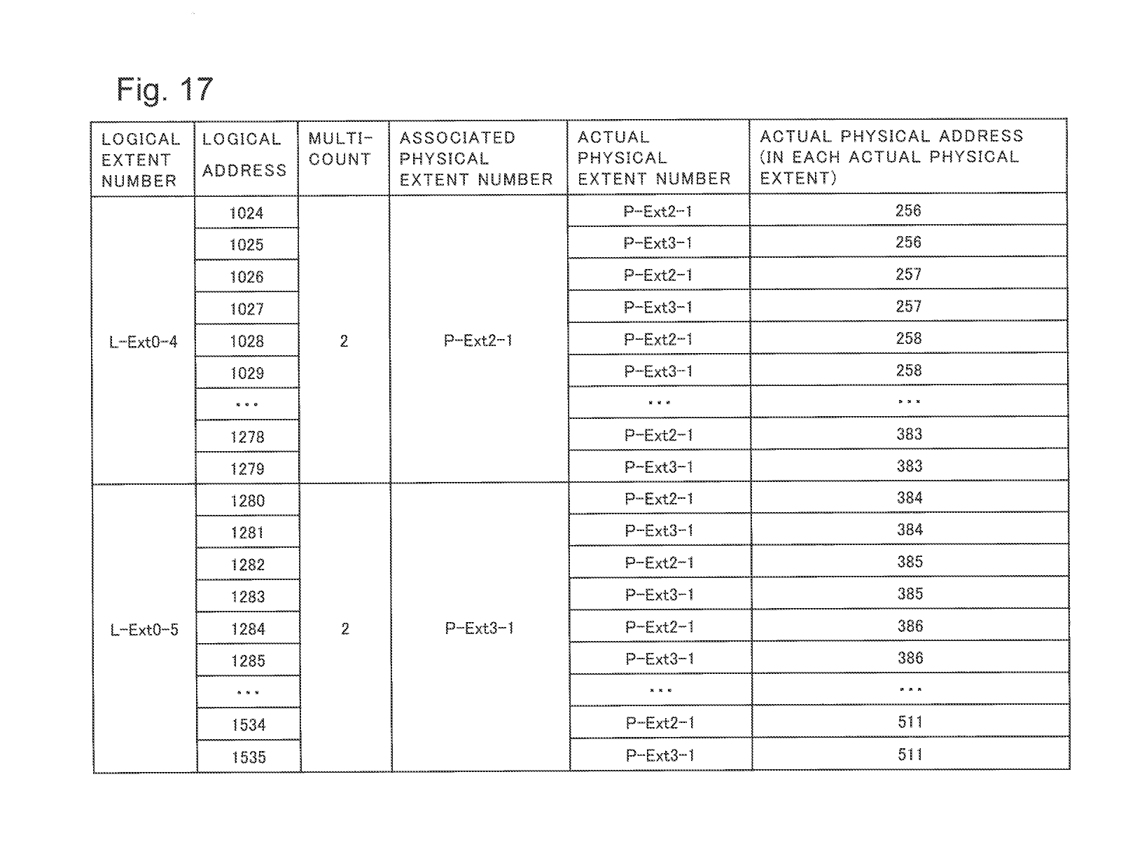

Similarly, as illustrated in FIG. 17, with each increase in the logical addresses of the logical extents L-Ext0-4 and L-Ext0-5, which are linked together with a multi-count of 2, an associated physical extent changes from P-Ext2-1 to P-Ext3-1 in this order.

In other words, a logical address space produced by configuring a multi-extent with a multi-count of 2 is arranged in two different physical extents in a distributed manner for every logical address. With this configuration, an access to an address space specified by the logical address is striped over different physical extents.

As described above, the storage controller 102 of the second exemplary embodiment, by taking into consideration a multi-count in a configuration of a multi-extent and a unit of striping, can distribute data accesses to logical addresses included in spaces composing the multi-extent over a plurality of physical extents.

With the storage apparatus 100 according to the second exemplary embodiment, the storage controller 102 configures a multi-extent by linking together logical extents which are associated with physical extents belonging to a plurality of different redundancy groups (e.g. redundancy groups 0 to 3 exemplified in FIG. 13, or the like) and arranged consecutively. The storage apparatus 100 can provide the host machine 101 with the logical disk 102h including the multi-extent as a storage space.

The storage controller 102 of the second exemplary embodiment configures multi-extent by linking together a plurality of logical extents using a multi-count.

The storage controller 102 can distribute an access to the multi-extent over different physical extents as many as the multi-count value. Specifically, the storage controller 102 of the second exemplary embodiment, by taking into consideration a multi-count in a configuration of a multi-extent and a unit of striping, can distribute data accesses to a logical address space included in logical extents composing the multi-extent over a plurality of physical extents.

As described above, with the storage apparatus according to the second exemplary embodiment, an access by the host machine 101 to specific data is, similarly to the above-described first exemplary embodiment, distributed over storage devices arranged in a plurality of different redundancy groups. Accordingly, the storage apparatus 100 according to the second exemplary embodiment provides an advantageous effect in that a load of storage devices can be reduced and access performance can be improved.

For example, it is assumed that a case in which the host machine 101 requests sequential reading of specific consecutive address spaces in the logical disk 102h. In this case, when the address spaces are included in a space configured with a multi-extent, is expected that an improvement in reading speed is proportional to a multi-count.

For example, it is assumed that another case in which the host machine 101 requests writing of data which can be contained in an address range provided by a(one) set of multi-extent. In this case, because the data is written to plural physical extents belonging to different redundancy groups, a load of the writing access is distributed over storage devices in a plurality of redundancy groups. Therefore, high writing performance may be expected.

The storage controller 102 of the second exemplary embodiment may be configured with separate dedicated hardware, as similarly to the first exemplary embodiment. The storage controller 102 may be configured with hardware configured by an processing unit such as a microprocessor 102d illustrated in FIG. 6 or the like and a memory referred to by the processing unit and various software programs executed by the processing unit. In this case, the above-described operation of the storage controller 102 is implemented by processing by software programs executed by the microprocessor 102d.

### Variation of Exemplary Embodiments

The configuration disclosed by each of the above-described exemplary embodiments may include variations described below.

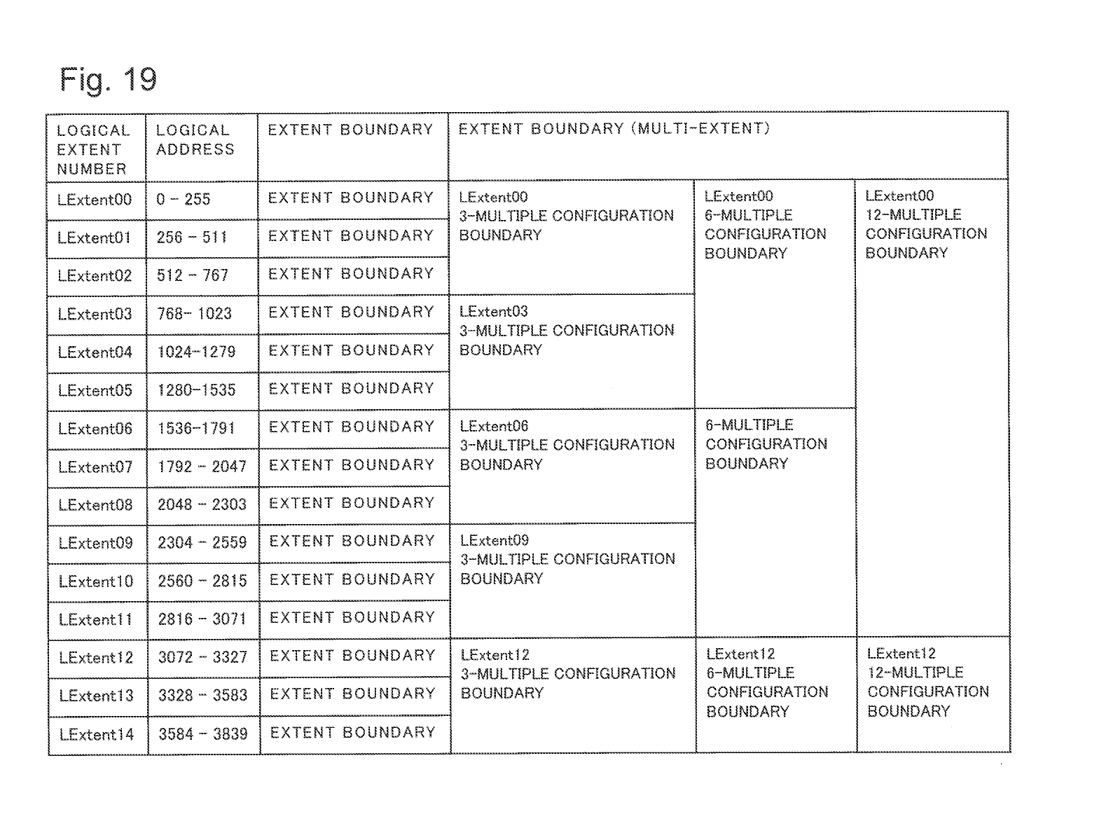

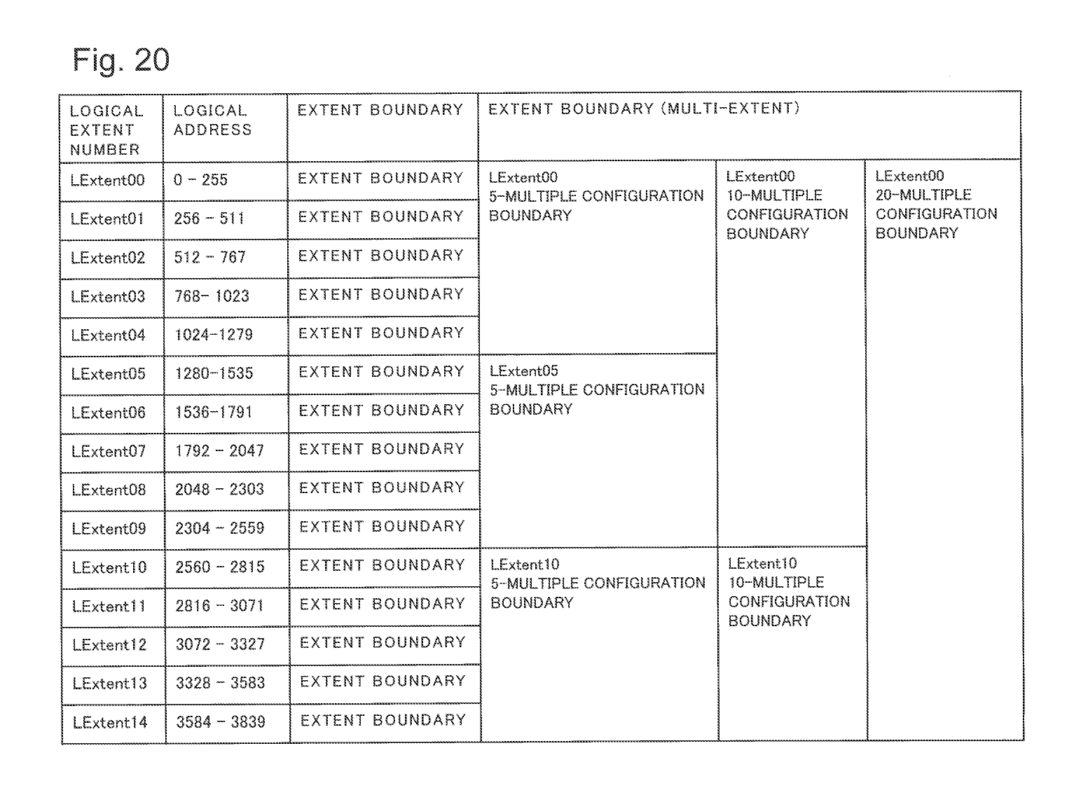

The above-described exemplary embodiments exemplified configurations for cases in which the base value for configurations of multi-extent is 2, and the number of logical extents composing the multi-extent is 2, 4, 8, or 16, i.e. powers of 2. However, the present invention is not limited to these cases. For example, the base value may be 3, and the number of logical extents composing multi-extent may be 3, 6, 12, or 24, i.e. products of the base value and powers of 2. For example, the base value may be 5, and the number of logical extents composing multi-extent may be 5, 10, 15, or 20, i.e. products of the base value and powers of 2. In these cases, the storage apparatus 100 also has advantageous effects similar to the effects in the above-described exemplary embodiments. FIGS. 19 and 20 show boundaries of multi-extent arranged on a logical disk when base values are 3 (FIG. 19), or 5 (FIG. 20), respectively.

The present invention has been described above by examples in which the present invention is applied to the above-described typical exemplary embodiment. However, technical scope of the present invention is not limited to the scope described in the above-described exemplary embodiments.

All or part of the exemplary embodiments and variations thereof described above may be described as in the following supplementary notes. However, the present invention described exemplarily by the above-described exemplary embodiments and variations thereof is not limited to the following supplementary notes.

### (Supplementary Note 1)

A storage apparatus, including:

one or more storage groups that are configured with one or more storage devices, associate specific storage spaces included in the one or more storage devices and provide the associated specific storage spaces as first physical storage spaces; and

a storage controller that configures a second logical storage space by associating a plurality of first logical storage spaces associated with the first physical storage spaces, and provides an external apparatus with a logical disk, to which the configured second logical storage space is allocated, as a storage space.

### (Supplementary Note 2)

The storage apparatus according to supplementary note 1,

wherein the storage controller associates a specific one of the first logical storage spaces composing the second logical storage space, with respect to each specific range, with a specific storage space in the first physical storage spaces associated with the first logical storage space, and a specific storage space in the first physical storage spaces associated with another one of the first logical storage spaces composing the second logical storage space, in order.

### (Supplementary Note 3)

The storage apparatus according to supplementary note 1 or 2,

wherein the plurality of first logical storage spaces included in the second logical storage space have association information by which the plurality of first logical storage spaces are associated together.

### (Supplementary Note 4)

wherein the association information includes information about the number of the first logical storage spaces included in the second logical storage space.

### (Supplementary Note 5)

The storage apparatus according to any one of supplementary notes 1 to 4,

wherein the storage controller

configures the second logical storage space with the plurality of first logical storage spaces, the number of which corresponds to a product of a base value and any power of 2, wherein the base value is the minimal number of first logical storage spaces included in the second logical storage space, and

associates the plurality of first logical storage spaces, that compose the second logical storage space, associated with the first physical storage spaces provided by different storage groups of which the number is the same as the number of the first logical storage spaces.

### (Supplementary Note 6)

The storage apparatus according to any one of supplementary notes 1 to 5,

wherein the association information includes a product of a base value, which is the minimal number of first logical storage spaces included in the second logical storage space, and any power of 2.

### (Supplementary Note 7)

The storage apparatus according to any one of supplementary notes 1 to 6,

wherein the storage controller assigns a beginning address of the second logical storage space to, at least, one of a beginning position of the logical disk, and a position offset, from the beginning position of the logical disk, by an integer multiple of a product of the base value and a size of an address range of the first logical storage space.

### (Supplementary Note 8)

The storage apparatus according to any one of supplementary notes 3 to 7,

wherein the storage controller, in response to a data access request from the external apparatus to the logical disk,

selects the second logical storage space that is allocated to a storage space including an access target logical address included in the data access request,

extracts the number of the first logical storage spaces composing the selected second logical storage space and the first logical storage space arranged to a beginning position of the selected second logical storage space, from the association information of the first logical storage spaces composing the selected second logical storage space,

computes an offset address of the access target logical address from a beginning address of the extracted fist logical storage space,

divides the computed offset address by a size of a full stripe which is product of the extracted number of the first logical storage spaces and a size of virtual striping,

specifies, by using a remainder resulted from the division, one of the first logical storage spaces including the access target logical address and composing the second logical storage space,

specifies one of the first physical storage spaces associated with the specified first logical storage space, and

specifies, by using a quotient resulted from the division, a physical address associated with the access target logical address in the specified first physical storage space.

### (Supplementary Note 9)

A control method of a storage apparatus which is carried out on an information processing apparatus, the method including:

associating specific storage spaces included in one or more storage devices composing a storage group;

configuring the associated specific storage spaces as first physical storage spaces;

configuring a second logical storage space by associating a plurality of first logical storage spaces associated with the first physical storage spaces; and

providing an external apparatus with a logical disk, to which the configured second logical storage space is allocated, as a storage space.

### (Supplementary Note 10)

A non-transitory computer readable recording medium storing a control program of a storage apparatus, the control program causing a computer to execute:

associating specific storage spaces included in one or more storage devices composing a storage group;

configuring the associated specific storage spaces as first physical storage spaces;

configuring a second logical storage space by associating a plurality of first logical storage spaces associated with the first physical storage spaces; and

providing an external apparatus with a logical disk, to which the configured second logical storage space is allocated, as a storage space.

### (Supplementary Note 11)

A storage apparatus, including:

one or more storage groups that are configured with one or more storage devices and provide physical storage spaces by linking together specific storage spaces included in the storage devices; and

a storage controller,

that configures a logical disk including a second logical storage space, to which first logical storage spaces are arranged, the first logical storage spaces being associated with the physical storage spaces provided by the storage groups differing from one another,

and provides an external apparatus with the configured logical disk as a storage space.

### INDUSTRIAL APPLICABILITY

The present invention is applicable to a storage apparatus or the like that provides a host machine with a logical storage space by integrating a plurality of physical storage devices, and associates physical storage spaces with logical storage spaces in a specific unit.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A storage apparatus, comprising:
one or more storage groups that are configured with one or more storage devices, associate specific storage spaces included in the one or more storage devices and provide the associated specific storage spaces as first physical storage spaces; and
a storage controller that configures a second logical storage space by associating a plurality of first logical storage spaces associated with the first physical storage spaces, and provides an external apparatus with a logical disk, to which the configured second logical storage space is allocated, as a storage space.

2. The storage apparatus according to claim 1,
wherein the storage controller associates, with respect to each specific range, a specific one of the first logical storage spaces composing the second logical storage space with a specific storage space in the first physical storage spaces associated with the first logical storage space, and a specific storage space in the first physical storage spaces associated with another one of the first logical storage spaces composing the second logical storage space, in order.

3. The storage apparatus according to claim 1,
wherein the plurality of first logical storage spaces included in the second logical storage space have association information by which the plurality of first logical storage spaces are associated together.

4. The storage apparatus according to claim 3,
wherein the association information includes information about the number of the first logical storage spaces included in the second logical storage space.

5. The storage apparatus according to claim 1, wherein the storage controller
configures the second logical storage space with the plurality of first logical storage spaces, the number of which corresponds to a product of a base value, which is the minimal number of first logical storage spaces included in the second logical storage space, and any power of 2, and
associates the plurality of first logical storage spaces composing the second logical storage space with the first physical storage spaces provided by storage groups differing from one another, the number of which is the same as the number of the first logical storage spaces.

6. The storage apparatus according to claim 3,
wherein the association information includes a product of a base value, which is the minimal number of first logical storage spaces included in the second logical storage space, and any power of 2.

7. The storage apparatus according to claim 5,
wherein the storage controller assigns a beginning address of the second logical storage space to, at least, one of a beginning position of the logical disk, and a position offset, from the beginning position of the logical disk, by an integer multiple of a product of the base value and a size of an address range of the first logical storage space.

8. The storage apparatus according to claim 3, wherein the storage controller, in response to a data access request from the external apparatus to the logical disk,
selects the second logical storage space that is allocated to a storage space including an access target logical address included in the data access request,
extracts the number of the first logical storage spaces composing the selected second logical storage space and the first logical storage space arranged to a beginning position of the selected second logical storage space, from the association information of the first logical storage spaces composing the selected second logical storage space,
computes an offset address of the access target logical address from a beginning address of the extracted fist logical storage space,
divides the computed offset address by a size of a full stripe which is product of the extracted number of the first logical storage spaces and a size of virtual striping,
specifies, by using a remainder resulted from the division, one of the first logical storage spaces including the access target logical address and composing the second logical storage space,
specifies one of the first physical storage spaces associated with the specified first logical storage space, and
specifies, by using a quotient resulted from the division, a physical address associated with the access target logical address in the specified first physical storage space.

9. A control method of a storage apparatus which is carried out on an information processing apparatus, the method comprising:
associating specific storage spaces included in one or more storage devices composing a storage group;
configuring the associated specific storage spaces as first physical storage spaces;
configuring a second logical storage space by associating a plurality of first logical storage spaces associated with the first physical storage spaces; and
providing an external apparatus with a logical disk, to which the configured second logical storage space is allocated, as a storage space.

10. A non-transitory computer readable recording medium storing a control program of a storage apparatus, the control program causing a computer to execute:
associating specific storage spaces included in one or more storage devices composing a storage group;
configuring the associated specific storage spaces as first physical storage spaces;
configuring a second logical storage space by associating a plurality of first logical storage spaces associated with the first physical storage spaces; and
providing an external apparatus with a logical disk, to which the configured second logical storage space is allocated, as a storage space.
